(19) United States
(12) Patent Application Publication
(10) Pub. No.: US 2017/0294212 A1
(43) Pub. Date: Oct. 12, 2017

(54) VIDEO CREATION, EDITING, AND SHARING FOR SOCIAL MEDIA

(71) Applicant: OMiro IP LLC, Lake Stevens, WA (US)

(72) Inventors: Dustin R. Allen, Las Vegas, NV (US); Andrew Kramer, Brooklyn, NY (US); Denis Tsai, Dallas, TX (US); Jay Oh, San Francisco, CA (US); Gregory Manriquez, Georgetown, TX (US); Stephen Callender, Austin, TX (US)

(73) Assignee: OMiro IP LLC, Lake Stevens, WA (US)

(21) Appl. No.: 15/622,030

(22) Filed: Jun. 13, 2017

Related U.S. Application Data
(63) Continuation-in-part of application No. 14/918,522, filed on Oct. 20, 2015.
(60) Provisional application No. 62/146,206, filed on Apr. 10, 2015.
(60) Provisional application No. 62/349,619, filed on Jun. 13, 2016.

(51) Int. Cl. G11B 27/031; H04N 21/854; H04N 21/475; G06Q 50/00; H04N 21/2743

(52) U.S. Cl. CPC G11B 27/031; G06Q 50/01; H04N 21/2743; H04N 21/475; H04N 21/854

(57) ABSTRACT

Embodiments of apparatuses, systems and methods for video creation, editing, and sharing for social media are described. In particular, the present embodiments include components for copying and pasting snippets of media from a first media file to a second media file at a desired location within the second media file. In a further embodiment, media snippets may be copied, cut, or pasted within a single media file. For example, in an embodiment, a snippet of video may be copied from a first video file, and pasted at a selected position within a timeline of a second video file. The media files may be pasted over each other completely. In another embodiment, audio may be pasted over existing video. In another embodiment video may be pasted over existing audio. In various alternative embodiments, the media snippet may be otherwise merged with the second media file.

### CROSS-REFERENCE TO RELATED APPLICATIONS

This application claims priority to U.S. patent application Ser. No. 14/918,522 entitled “VIDEO CREATION, EDITING, AND SHARING FOR SOCIAL MEDIA, filed on Dec. 20, 2015, which claims the benefit of U.S. Provisional Pat. App. No. 62/146,206 filed on Apr. 10, 2015. Additionally, this application claims priority to U.S. Provisional Pat. App. No. 62/349,619, filed on Jun. 13, 2016.

### FIELD

This disclosure relates generally to social media, and more specifically, to video creation, editing, and sharing for social media.

### BACKGROUND

The uploading of video recording content to web pages and social media networks is now a common activity. These videos are presented for other viewers to watch. The interaction with the video content usually ends there as the videos are not easily presented for additional users to edit and manipulate the video footage that they have watched. Editing and interacting with video content is a cumbersome process requiring video download capability and editing software that exists separately from the video player where the video was displayed.

Viewers of online video recordings are commonly encouraged to reply to the video recordings with text based responses. Video based responses to the original video are only linked through text based responses and linking actions that maintain a level of distance between the original content and new related content. The creation of new videos related to the original video does not offer any seamless interaction or direct integration with the original video content.

### SUMMARY

Embodiments of apparatuses, systems and methods for video creation, editing, and sharing for social media are described.

A method, comprising:
receiving a request for access to a media comment thread from a user interface device; uploading a media file to the user interface device for editing;
receiving a media comment from the user interface device for including in the media comment thread.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a schematic block diagram illustrating one embodiment of a system for video creation, editing, and sharing for social media.

FIG. 2 is a schematic block diagram illustrating another embodiment of a system for video creation, editing, and sharing for social media.

FIG. 3 is a schematic block diagram illustrating one embodiment of a computer system configurable for video creation, editing, and sharing for social media.

FIG. 4 is a schematic block diagram illustrating one embodiment of an apparatus for video creation, editing, and sharing for social media.

FIG. 5 is a schematic block diagram illustrating another embodiment of an apparatus for video creation, editing, and sharing for social media.

FIG. 6 is a flowchart diagram illustrating one embodiment of a method for video creation, editing, and sharing for social media.

FIG. 7 is a flowchart diagram illustrating one embodiment of a method for video creation, editing, and sharing for social media.

FIG. 8 is a flowchart diagram illustrating one embodiment of a method for video creation, editing, and sharing for social media.

FIG. 9 is a diagram illustrating one embodiment of a method for video editing.

FIG. 10A is a diagram illustrating one embodiment of a process for video creation, editing, and sharing for social media.

FIG. 10B is a diagram illustrating one embodiment of a process for video creation, editing, and sharing for social media.

FIG. 10C is a diagram illustrating one embodiment of a process for video creation, editing, and sharing for social media.

FIG. 10D is a diagram illustrating one embodiment of a process for video creation, editing, and sharing for social media.

FIG. 11 is a screenshot diagram illustrating one embodiment of a home screen of a Graphical User Interface (GUI) of a software application for video creation, editing, and sharing for social media.

FIG. 12 is a screenshot diagram illustrating one embodiment of a user interface for displaying a social media user profile.

FIG. 13 is a screenshot diagram illustrating one embodiment of a video editing screen on a GUI of a software application for video creation, editing, and sharing for social media.

FIG. 14 is a screenshot diagram illustrating one embodiment of a video editing screen on a GUI of a software application for video creation, editing, and sharing for social media.

FIG. 15 is a screenshot diagram illustrating one embodiment of a video editing screen on a GUI of a software application for video creation, editing, and sharing for social media.

FIG. 16 is a screenshot diagram illustrating one embodiment of video filter selection screen on a GUI of a software application for video creation, editing, and sharing for social media.

FIG. 17 is a screenshot diagram illustrating one embodiment of a media publication GUI of a software application for video creation, editing, and sharing for social media.

FIG. 18A is a screenshot diagram illustrating one embodiment of a GUI for promotional content creation, sharing, and payment.

FIG. 18B is a screenshot diagram illustrating one embodiment of a GUI for promotional content creation, sharing, and payment.

FIG. 18C is a screenshot diagram illustrating one embodiment of a GUI for promotional content creation, sharing, and payment.

FIG. 19 is a screenshot diagram illustrating one embodiment of a GUI for summarizing advertising campaign details.

FIG. 20A is a screenshot diagram illustrating one embodiment of a GUI for creating an advertising campaign.

FIG. 20B is a screenshot diagram illustrating one embodiment of a GUI for creating an advertising campaign.

FIG. 21 is a schematic functional diagram illustrating an embodiment of a system for video creation, editing, and sharing for social media.

FIG. 22 is a schematic functional diagram illustrating an embodiment of a system for video creation, editing, and sharing for social media.

FIG. 23 is a flowchart diagram illustrating an embodiment of a method for video creation, editing, and sharing for social media.

FIG. 24 is a screenshot diagram illustrating one embodiment of a GUI for copy, cut, and paste functions.

FIG. 25 is a screenshot diagram illustrating one embodiment of a GUI for copy, cut, and paste functions.

FIG. 26 is a screenshot diagram illustrating one embodiment of a GUI for copy, cut, and paste functions.

FIG. 27 is a screenshot diagram illustrating one embodiment of a GUI for copy, cut, and paste functions.

FIG. 28 is a screenshot diagram illustrating one embodiment of a GUI for generating a cover burst.

FIG. 29 is a screenshot diagram illustrating one embodiment of a GUI for displaying a cover burst in a user feed.

FIG. 30 is a schematic flowchart diagram illustrating one embodiment of a method for creating jumpcut media from a website source.

FIG. 31 is a schematic flowchart diagram illustrating one embodiment of a method for creating an independent jumpcut thread.

FIG. 32 illustrates an embodiment of an interactive video cycle.

FIG. 33A illustrates an embodiment of a process for generating jumpcut media commentary.

FIG. 33B illustrates an embodiment of a process for generating jumpcut media commentary.

FIG. 33C illustrates an embodiment of a process for generating jumpcut media commentary.

### DETAILED DESCRIPTION

The present embodiments include components for copying and pasting snippets of media from a first media file to a second media file at a desired location within the second media file. In a further embodiment, media snippets may be copied, cut, or pasted within a single media file. For example, in an embodiment, a snippet of video may be copied from a first video file, and pasted at a selected position within a timeline of a second video file. The media files may be pasted over each other completely. In another embodiment, audio may be pasted over existing video. In another embodiment video may be pasted over existing audio. In various alternative embodiments, the media snippet may be otherwise merged with the second media file.

Such embodiments may include creation or designation of a virtual clipboard. The virtual clipboard may comprise a segment of memory designated by a video editing application for storage of media snippets copied or cut from the first media file. When the media snippet has been sent to the clipboard, an indicator may indicate to the user that the media snippet is available for pasting into a second media file. Controls within the application, and operated by the user, may determine how the media snippet is merged with the second media file.

In a further embodiment, a media snippet may be selected for display in a user feed of the social media platform. In such an embodiment, the media snippet may be referred to as a “cover burst.” The cover burst may include a segment of media, of a predetermined length, which is displayed and automatically played in a user feed. In a further embodiment, the media snippet may be down-sampled, compressed, or otherwise converted to a reduced data size, such that display of the cover burst in the user feed does not consume as much data bandwidth as would be the case with the original media snippet. In a further embodiment, cover burst may be looped, repeating either a predetermined number of times, or indefinitely until the user either scrolls past the displayed cover burst or selects the media file associated with the cover burst. In particular, the cover burst may be a three second snippet of video shown in a user feed in a preview loop. In a further embodiment, the cover burst may include a selectable area and an icon indicating that the cover burst is selectable for further playing of the associated media file. In such an embodiment, the icon may be a “play button,” such as a triangle shaped icon.

Additionally, the present embodiments describe methods and systems for generating and facilitating user operation of a video comment thread on a web page. A web page administrator may incorporate code for accessing a video comment thread service or widget from a video commenting platform for inclusion on a web page. Users of the web page may request access to a media file for editing on a user interface. The server may upload the media file to the user interface and receive an edited version of the media file back from the user interface. The edited version of the media file may be the content of the video comment, which may be displayed on the hosting web site.

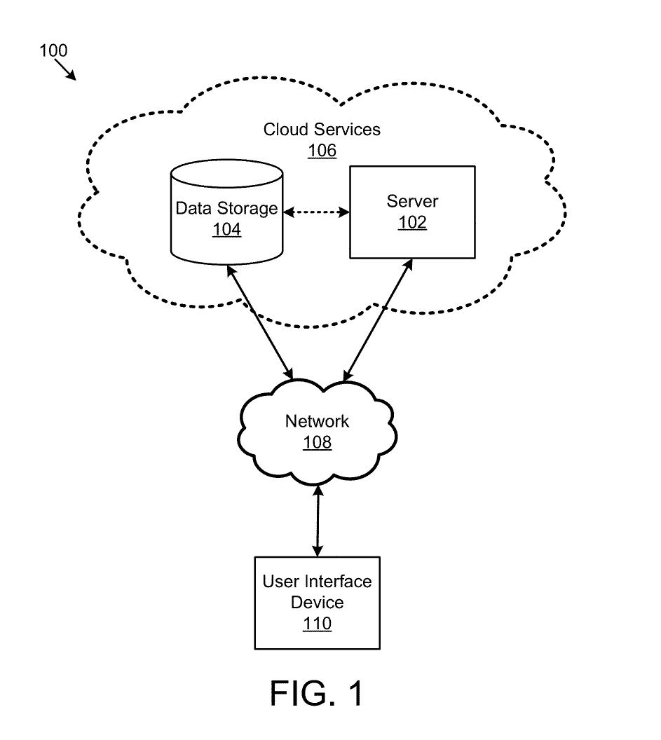

FIG. 1 is a schematic block diagram illustrating one embodiment of a system 100 for video creation, editing, and sharing for social media. In an embodiment, the system 100 includes a server 102, a data storage device 104, a network 108, and a user interface device 110. In certain embodiments, the data storage device 104 and/or the server 102 may be implemented in a cloud services system 106. In further embodiments, the data storage device 104 may be directly accessible by the server 102. The server 102 and/or the data storage device 104 may communicate with the network 108. The user interface device 110 may also communicate with the network 108. In further embodiments, communications between the server 104, the data storage device 104, and/or the user interface device 110 may be conducted via the network 108.

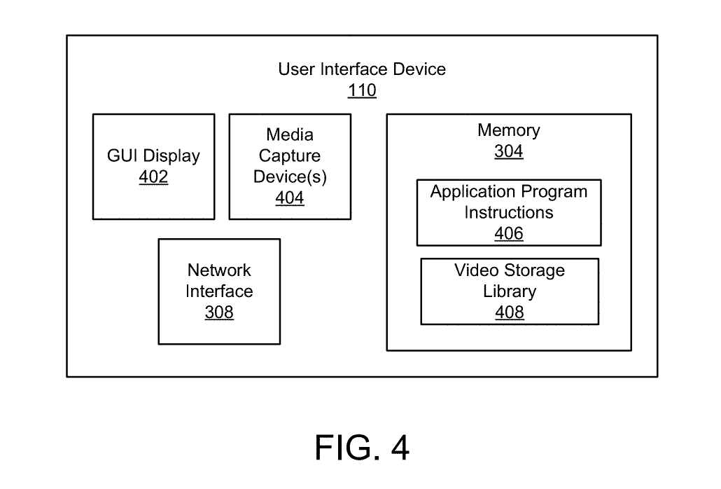

As further described in the embodiments below, the system 100 may implement video creation, editing and sharing functions for social media. For example, the user interface device 110, as illustrated in FIG. 4, may include a video capture device, a data storage device comprising a library of video content, or a data connection to a storage device comprising video content. The user interface device 110 may additionally comprise memory for loading program instructions, that when executed by a processor of the user interface device 110, cause the user interface device to execute a special purpose video creation, editing and sharing application or “app.” The application may provide a user interface for controlling video capture, editing, sharing, and other content manipulation functions carried out by the user interface device 110. The user interface device 110 may also include a network interface for communicating video content, editing data or metadata, user data, and the like to the server 102 and/or to the data storage 104 over the network 108.

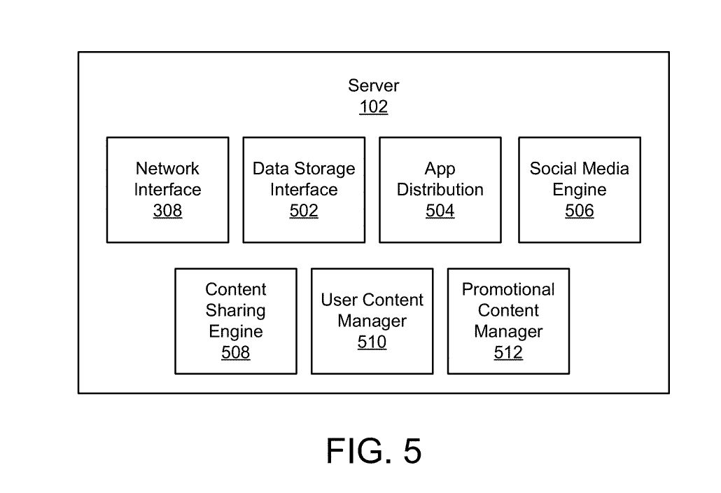

The server 102, as further illustrated in FIG. 5, may provide centralized control of distribution of the application. In another embodiment the server 102 may provide centralized control or management of video editing data, shared content, social network connections, user profile data, advertisements and other revenue content, and the like. Once executed on the user interface device 110, the application may access the server 102 to download content to be displayed to the user. Additionally, shared content may be uploaded to the server 102 or to the data storage device 104 for sharing with the user's social network.

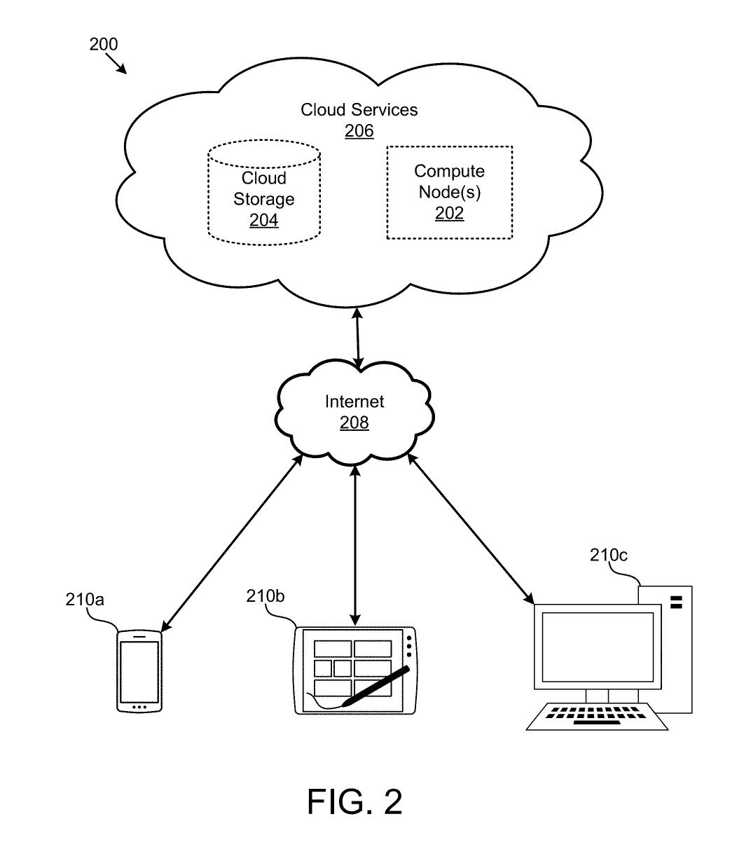

FIG. 2 is a schematic block diagram illustrating another embodiment of a system 200 for video creation, editing, and sharing for social media. In the embodiment of FIG. 2, the system 200 includes a cloud services system 206 coupled to the Internet 208. One or more user interface devices 110, such as user equipment 210a-c may connect to the cloud services 206 through the Internet 208. User equipment may include, for example, a smartphone 210a, a tablet computer 210b, a desktop computer 210c, or other equipment not depicted, but readily identifiable by one of ordinary skill in the art. For example, other embodiments, may include laptop computers, smart watch devices, personal data assistants (PDAs), smart televisions, media interface devices, or the like. In certain embodiments, the cloud services 206 may include cloud storage 204 and/or one or more compute node(s) 202. The compute node(s) 202 may operate as a server 102 in certain embodiments.

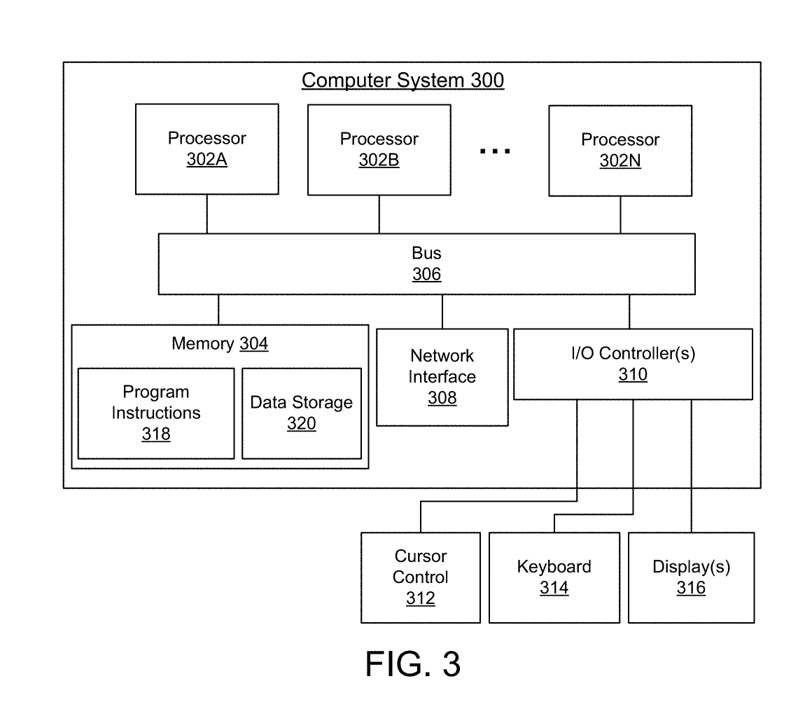

FIG. 3 is a schematic block diagram illustrating one embodiment of a computer system 200 configurable for video creation, editing, and sharing for social media. In one embodiment, server 102 and/or user interface device 110 may be implemented on a computer system similar to the computer system 300 described in FIG. 3. Similarly, aspects of cloud services 206 may be implemented on a computer system 300 similar to the computer system 300 described in FIG. 3. Smartphone 210a, tablet 210b, and/or computer 210c may also be implemented on a computer system similar to the computer system 300. In various embodiments, computer system 300 may be a server, a mainframe computer system, a cloud services system, a workstation, a network computer, a desktop computer, a laptop, or the like.

As illustrated, computer system 300 includes one or more processors 302A-N coupled to a system memory 304 via bus 306. Computer system 300 further includes network interface 308 coupled to bus 306, and input/output (I/O) controller(s) 310, coupled to devices such as cursor control device 312, keyboard 314, and display(s) 316. In some embodiments, a given entity (e.g., server 110) may be implemented using a single instance of computer system 300, while in other embodiments multiple such systems, or multiple nodes making up computer system 300, may be configured to host different portions or instances of embodiments (e.g., cloud services 206).

In various embodiments, computer system 300 may be a single-processor system including one processor 302A, or a multi-processor system including two or more processors 302A-N (e.g., two, four, eight, or another suitable number). Processor(s) 302A-N may be any processor capable of executing program instructions. For example, in various embodiments, processor(s) 302A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 302A-N may commonly, but not necessarily, implement the same ISA. Also, in some embodiments, at least one processor(s) 302A-N may be a graphics processing unit (GPU) or other dedicated graphics-rendering device.

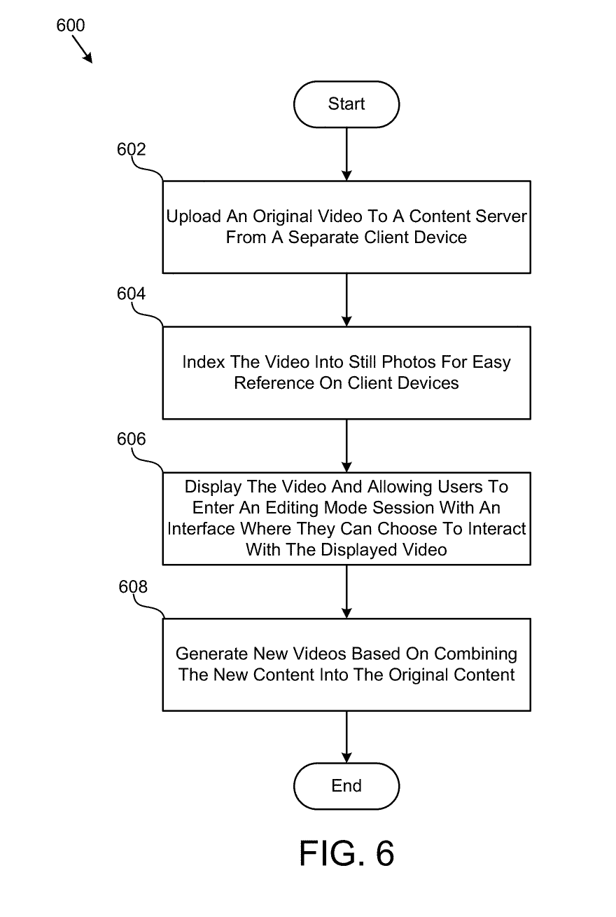

System memory 304 may be configured to store program instructions and/or data accessible by processor(s) 302A-N. For example, memory 304 may be used to store software program and/or database shown in FIGS. 6-9. In various embodiments, system memory 304 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 304 as program instructions 318 and data storage 320, respectively. In other embodiments, program instructions and/or data may be received, sent or stored upon different types of computer-accessible media or on similar media separate from system memory 304 or computer system 300. Generally speaking, a computer-accessible medium may include any tangible, non-transitory storage media or memory media such as electronic, magnetic, or optical media-e.g., disk or CD/DVD-ROM coupled to computer system 300 via bus 306, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 306 may be configured to coordinate I/O traffic between processor 302, system memory 304, and any peripheral devices including network interface 308 or other peripheral interfaces, connected via I/O controller(s) 310. In some embodiments, bus 306 may perform any necessary protocol, timing or other data transformations to convert data signals from one component (e.g., system memory 304) into a format suitable for use by another component (e.g., processor(s) 302A-N). In some embodiments, bus 306 may include support for devices attached through various types of peripheral buses, such as a variant of the Peripheral Component Interconnect (PCI) bus standard or the Universal Serial Bus (USB) standard, for example. In some embodiments, the operations of bus 306 may be split into two or more separate components, such as a north bridge and a south bridge, for example. In addition, in some embodiments some or all of the operations of bus 306, such as an interface to system memory 304, may be incorporated directly into processor(s) 302A-N.

Network interface 308 may be configured to allow data to be exchanged between computer system 300 and other devices, such as other computer systems attached to network 108 or Internet 208, for example. In various embodiments, network interface 308 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 310 may, in some embodiments, enable connection to one or more display terminals, keyboards, keypads, touch screens, scanning devices, voice or optical recognition devices, or any other devices suitable for entering or retrieving data by one or more computer system 300. Multiple input/output devices may be present in computer system 300 or may be distributed on various nodes of computer system 300. In some embodiments, similar I/O devices may be separate from computer system 300 and may interact with computer system 300 through a wired or wireless connection, such as over network interface 308.

As shown in FIG. 3, memory 304 may include program instructions 318, configured to implement certain embodiments described herein, and data storage 320, comprising various data accessible by program instructions 318. In an embodiment, program instructions 318 may include software elements of embodiments illustrated in FIGS. 6-10D. For example, program instructions 318 may be implemented in various embodiments using any desired programming language, scripting language, or combination of programming languages and/or scripting languages. Data storage 320 may include data that may be used in these embodiments such as, for example, video content and/or editing data. In other embodiments, other or different software elements and data may be included.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

FIG. 4 is a schematic block diagram illustrating one embodiment of an apparatus for video creation, editing, and sharing for social media. FIG. 4 illustrates an embodiment of a user interface device 110. The user interface device 110 may include a Graphical User Interface (GUI) display 402, such as a touchscreen, monitor, or the like configured to display a GUI of the application program. The user interface device 110 may also include one or more media capture devices 404, such as a video camera, a still camera, and/or a microphone. Additionally, The user interface device 110 may include a network interface 308 for communicating over the network. The user interface device 110 may additionally include a memory device 304 configured to store application program instructions 406 for execution of the Videotape App as well as a video storage library 408.

FIG. 5 is a schematic block diagram illustrating another embodiment of an apparatus for video creation, editing, and sharing for social media. In an embodiment, the apparatus of FIG. 5 is representative of the server 102. The server 102 may include a network interface 308 a data storage interface 502 for communication with data storage device 104, an application distribution engine 504 for distributing application program code to user interface devices 110, a social media engine 506 configured to manage a social media network of users, a content sharing engine 508 for allowing users to share video content over the social media network, a user content manager 510 for managing Jumpcut layers and uploaded media content, and a promotional content manager 512 for managing creation and distribution of marketing ads and other promotional content to the social network.

FIG. 6 is a flowchart diagram illustrating one embodiment of a method 600 for video creation, editing, and sharing for social media. In an embodiment, the method 600 may include uploading an original video to a content server from a separate client device, as shown at block 602. At block 604, the method 600 may include indexing the video into still photos for easy reference on client devices. Also, the method 600 may include displaying the video and allowing users to enter an editing mode session with an interface where they can choose to interact with the displayed video as shown at block 606. At block 608, the method may include generating new videos based on combining the new content into the original content.

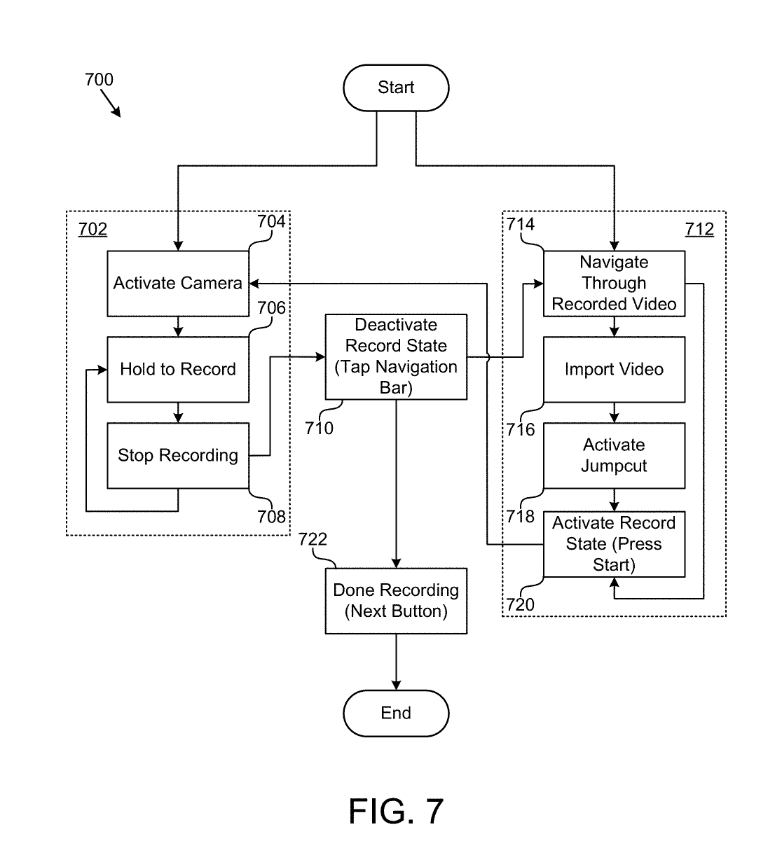

FIG. 7 is a flowchart diagram illustrating one embodiment of a method 700 for video creation, editing, and sharing for social media. In an embodiment, the method 700 starts with a decision to either start a new original video or to start editing an existing video. If an original video is selected, then a record state is initiated as shown at block 702. In the record state 702, a camera may be activated as sown at block 704. A record button may be held to initiate a video capture as shown at block 706. When the button is released, the recording may be stopped as shown at block 708. In some embodiments, the record button may be a graphical button displayed on a touchscreen device. The record state 702 may be deactivated as shown at block 710, when for example, a navigation bar is tapped.

If it is determined that an existing video is to be edited (referred to herein as “Jumpcut”), then a navigation state 712 is activated. In an embodiment, the method 700 may include navigating through a recorded video as shown at block 714. In certain embodiments, media such as audio, video, or other effects may be imported at block 716. The Jumpcut menu may be activated at block 718. New video may be added to the existing video by activating a record state at block 720. For example, a start button may be selected. As described in greater detail below, a combination of the navigation state and the record state may be used to add original content to an existing video, add previously recorded content to an existing video, add voice or music to an existing video, or the like. Upon completion of the recording and/or editing, the application may move to a next set of screens for publishing the media, tagging the media with metadata, adding promotional content, or the like as shown at block 722.

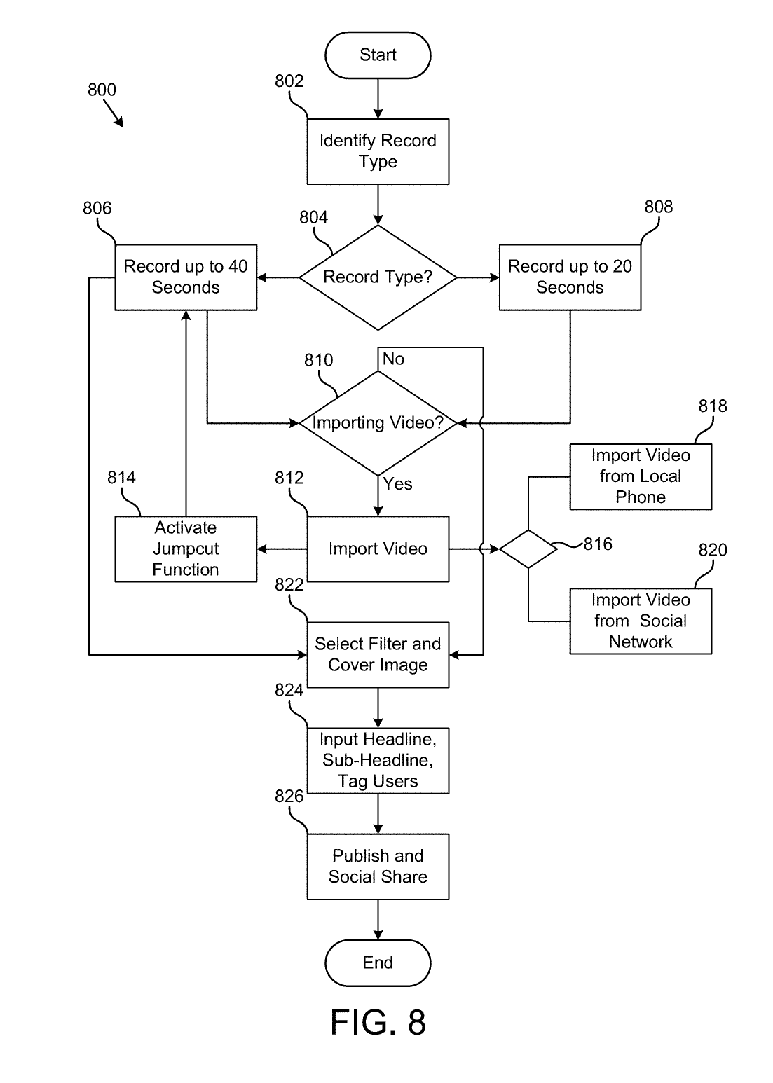

FIG. 8 is a flowchart diagram illustrating one embodiment of a method 800 for video creation, editing, and sharing for social media. The method 800 of FIG. 8 illustrates aspects of the method described in FIG. 7, including determining whether a record type is original recording or existing recording as shown at blocks 802-804. New content may be recorded and added to the recording. In an embodiment, up to 40 seconds can be added in a first mode, as shown at blocks 806, and up to 20 seconds of video may be recorded as shown at block 808. If it is determined at block 810 that video is to be imported, then the new video may be imported at block 812 and the Jumpcut function may be activated at block 814. The video may be imported from a local recording device as shown at block 818, or imported from social media as shown at block 820, as decided at block 816. The imported media may include video, voice recording, audio tracks, images, etc. Upon successful recording and or importation of media, a filter may be applied and/or a cover image may be selected as shown at block 822. In an embodiment, certain filters may be applied to the video and/or audio. Text may be added to the video, including headlines, sub-headlines, user tags, metadata, etc. as shown at block 824. The video may then be published or shared to the social network, or to extended social networks via plugins to alternative apps as shown at block 826.

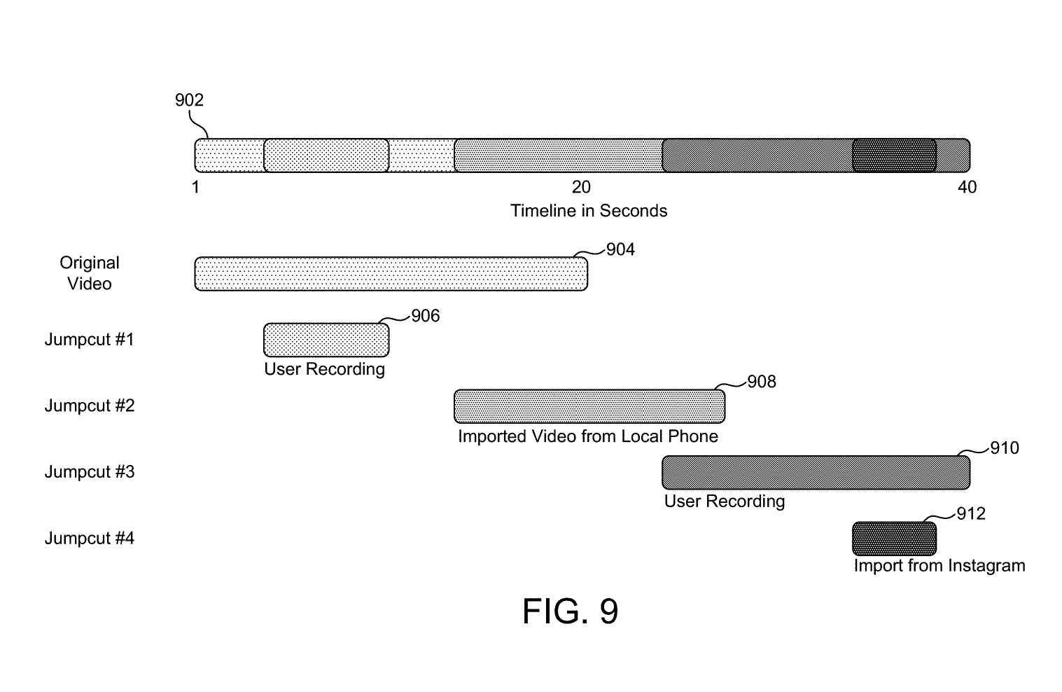

FIG. 9 is a diagram illustrating one embodiment of a method for video editing. In an embodiment, an original video may be edited by overlaying additional video, voice recordings, imported media, etc. Each layer may be referred to as a “Jumpcut.” FIG. 9 illustrates how a 40 second edited video 902 may be created from a 20 second original video 904. In Jumpcut #1, a user recording 906, such as captured voice, video, or image may be overlaid on the original video 904 at a user-selected point in the original video. At Jumpcut #2, imported media 908, such as video, may be added from the local platform, such as a smartphone. The imported video 908 may overwrite the original video at a user-selected point, and may extend the total video length beyond 20 seconds. A second user recording 910, such as voice or video may be added at Jumpcut #3. At Jumpcut #4, an imported image 912, such as from another social media platform, may be added to the video timeline at a user-selected point. Thus, the final edited video may include the original video, plus four additional layers representing Jumpcuts #1-4. One of ordinary skill will recognize that additional editing, including application of filters, titles, credits, etc. may be included in additional Jumpcuts.

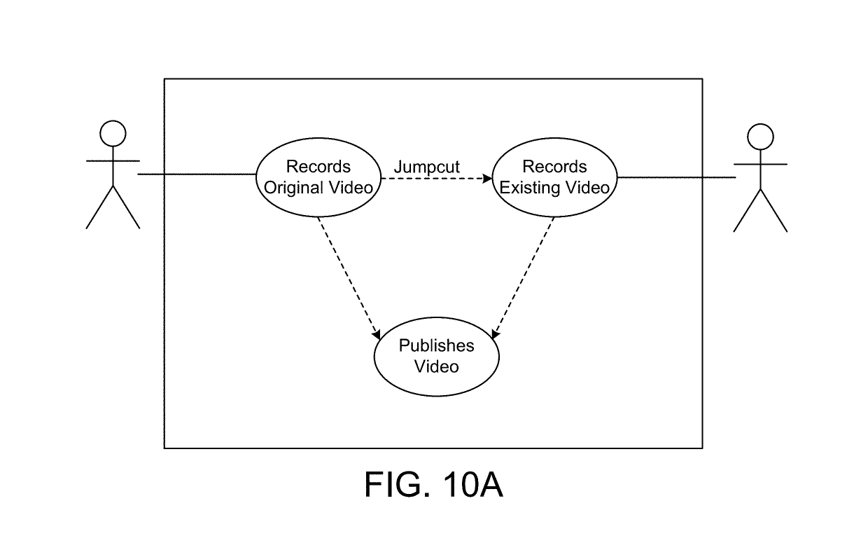

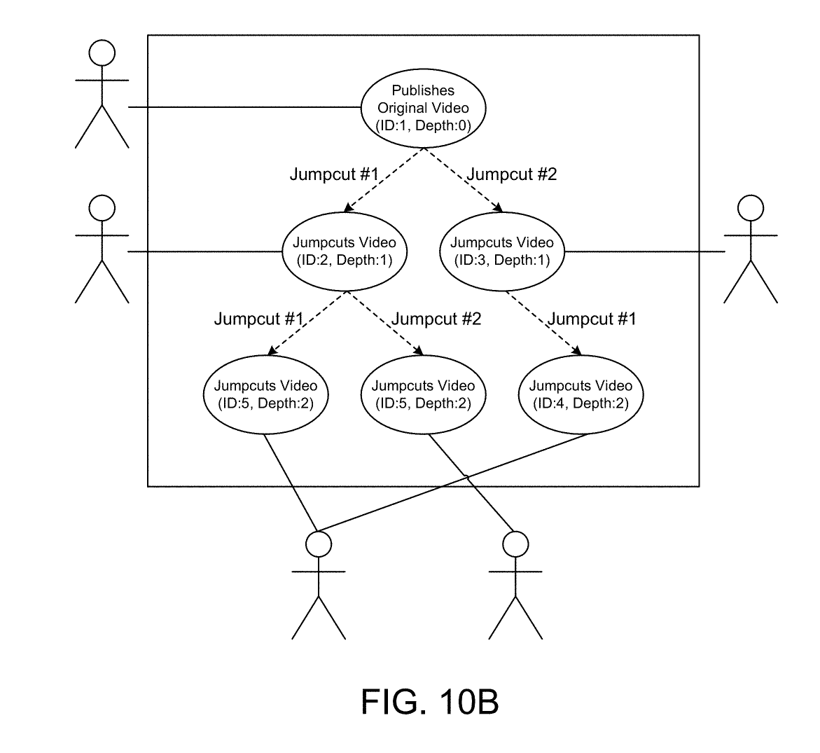

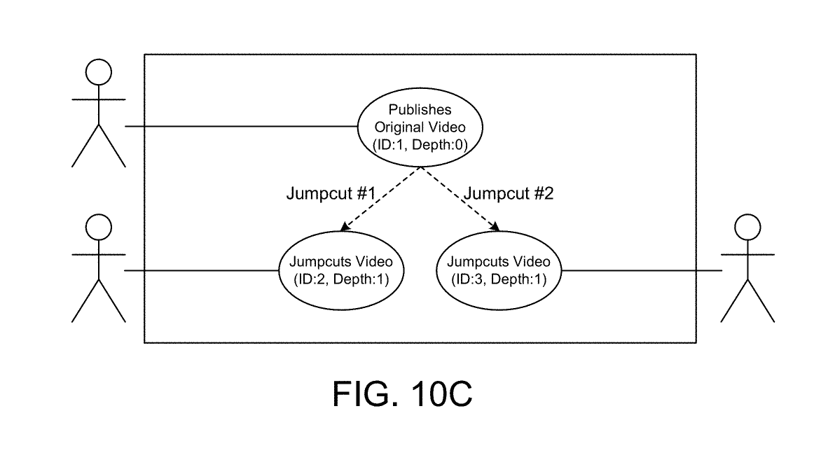

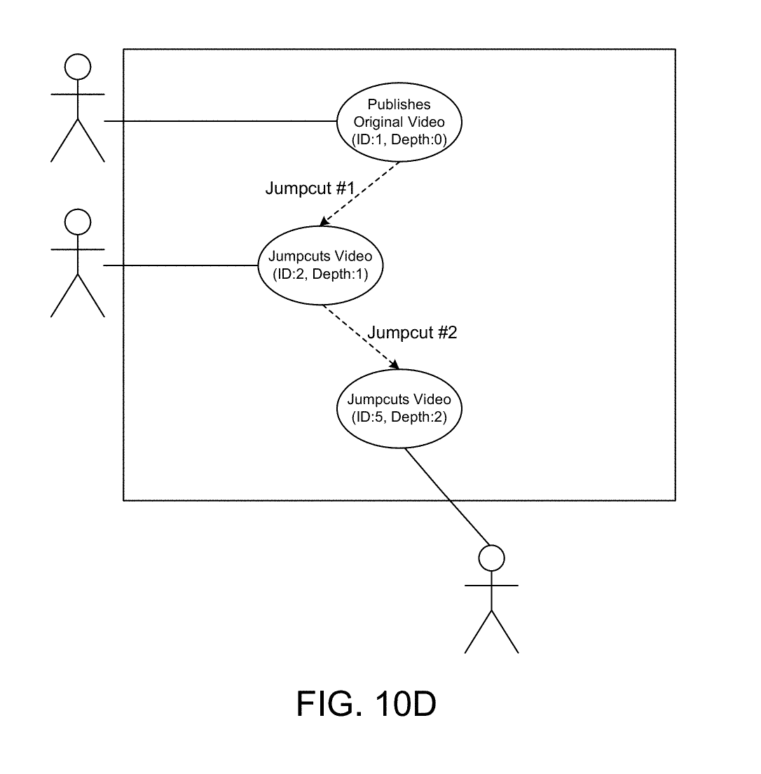

FIG. 10A is a diagram illustrating one embodiment of a process for video creation, editing, and sharing for social media. In the embodiment of FIG. 10A, a first phase of a video lifecycle is illustrated. In the depicted embodiment, a user creates an original video by recording content with his smartphone, uploading video from another video capture device, or uploading previously recorded video. The user may then edit the video as he chooses using the Jumpcut features previously described. In one embodiment, the user may then directly publish the video, and/or make the video available to a friend for editing. The friend may add to or edit the original video as an existing video using the Jumpcut features previously described. The friend may also publish the edited video.

In the embodiment described in FIG. 10B, the user may publish the original video, which may be edited using Jumpcuts by a first friend and separately by a second friend. Each of the first friend and the second friend may publish the video. A third friend may be friends with both of the first and the second friends. Therefore the third friend may be able to Jumpcut and publish edited versions of the videos published by both the first friend and the second friend. A fourth friend may be friends with the first friend, but not with the second friend. Therefore, only the edited videos published by the first friend may be available for viewing, editing and republishing by the fourth friend. Thus, a social network-based hierarchy of published videos, each based on the original video may be established.

FIG. 10C illustrates a representation of an arrangement of original video with child videos. The original video may be given an Identification (ID) number and a Depth number. The ID number may be used to associated the video with the user who publishes it, the original video, or some other parameter for arranging and managing videos. In the described example, the original video is given ID #1 with a depth level of 0, because it is the original video. The first friend may create a second video with Jumpcut #1, which is given ID #2 and has a depth of 1, i.e, one level from the original video. Similarly, the second friend may create another new video with Jumpcut #2 and the new video is given ID #3, and is also at depth 1 because it is only one Jumpcut level from the original video.

The embodiment of FIG. 10D illustrates how a fourth friend may access the Jumpcut video ID #2 from the first friend and add another Jumpcut #2 to the video. The resulting edited video may be given ID #5, and may be assigned a depth of 2, because it is two sets of Jumpcuts away from the original video. The ID and depth numbers may be used by the server 102, or by a database management system associated with the data storage device 104 for managing the organization of content uploaded for publishing by the system users. For example, the ID number may be used as a pointer or tag for referencing additional videos to original content. Depth numbers may be used to ensure that all appropriate layers of Jumpcuts are applied to the given published video, etc.

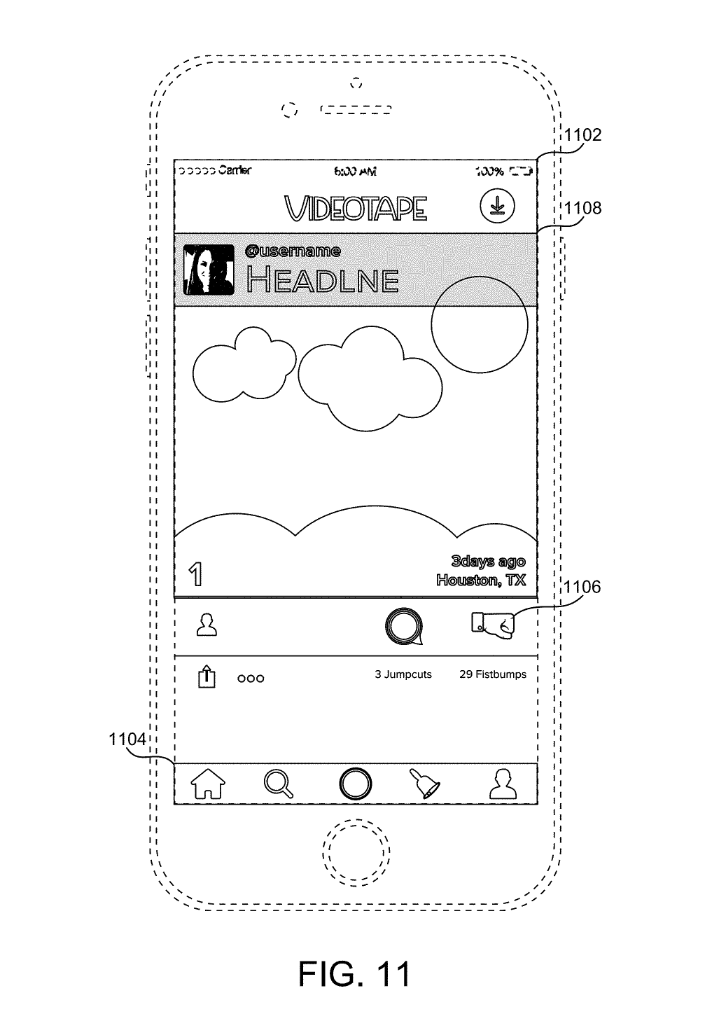

FIG. 11 is a screenshot diagram illustrating one embodiment of a home screen 1102 of a Graphical User Interface (GUI) of a software application for video creation, editing, and sharing for social media. The home screen 1102 may include a video feed 1108 or newsfeed of content shared by other members of the social media network. Additionally, the home screen 1102 may include controls 1106 for editing video shared on the user's feed or for providing positive feedback on media shared on the user's feed. Additionally, the home screen 1102 may include additional controls 1104 for navigating to screens for recording new content, searching for previously shared content or related users, providing user profile information, or the like.

In certain embodiments, a positive reinforcement action, such as a graphical fist bump, may be displayed on a GUI of a software application for video creation, editing, and sharing for social media. For example, when the user selects a “fist bump” icon, two fists may appear on the video and bump together graphically. Once the video is bumped, the fist bump icon may be colored or shaded and the video may be tagged as bumped by the user, which may be displayed to other users, including the creator of the content.

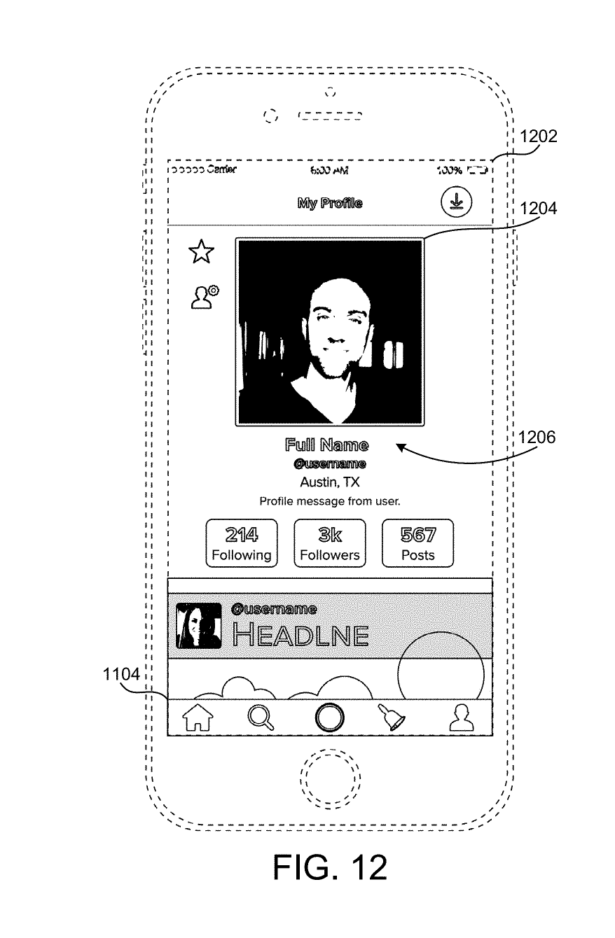

FIG. 12 is a screenshot diagram illustrating one embodiment of a user interface for displaying a social media user profile 1202. In an embodiment, the user interface 1202 may include a profile picture 1204. The user profile 1202 may also include personal profile information, including a name, user handle, location, number of followers, number of posts, and the like. The profile screen 1202 may also include the navigation controls 1104.

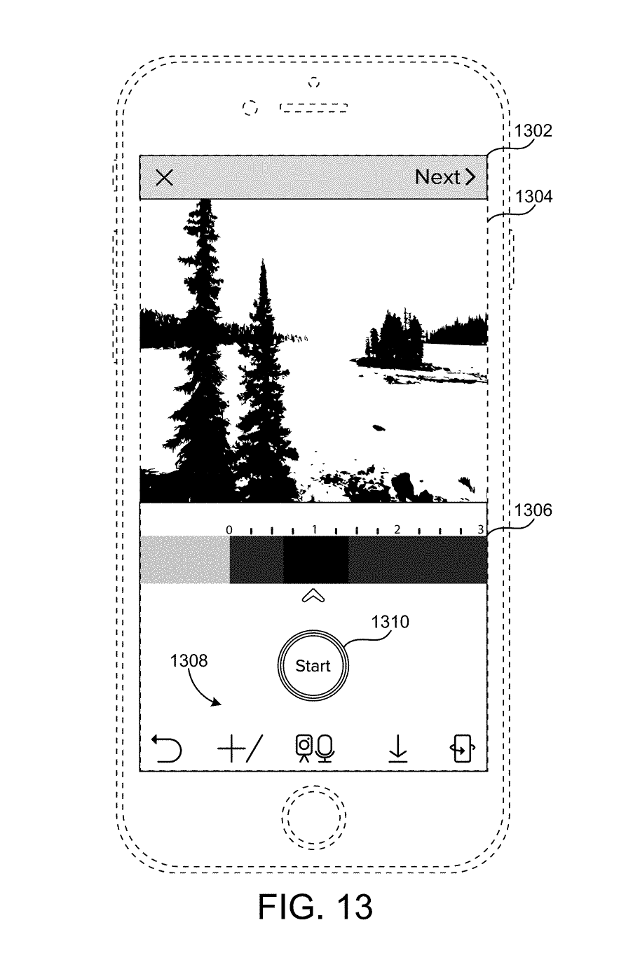

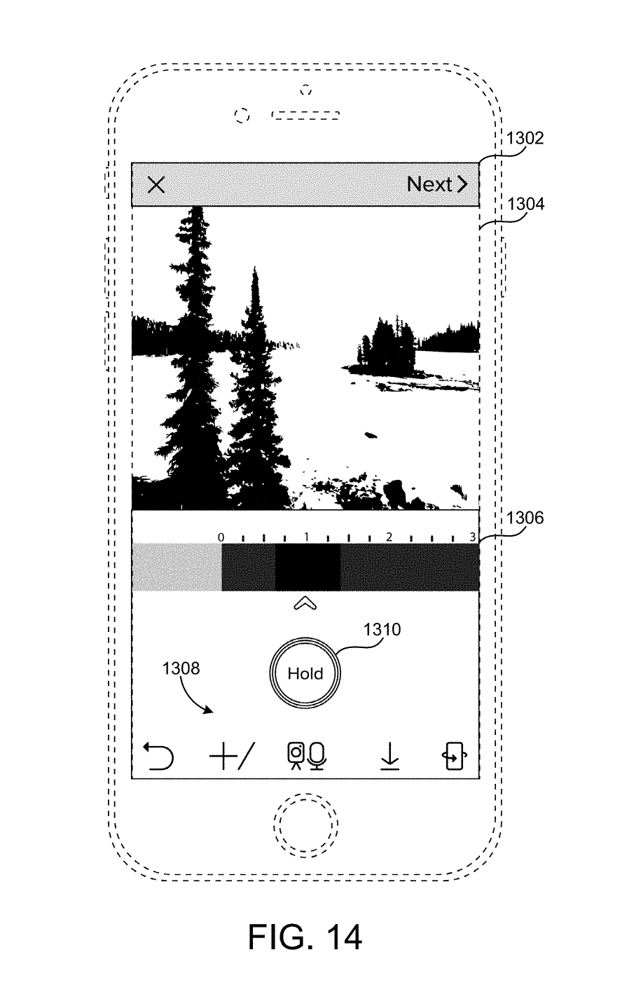

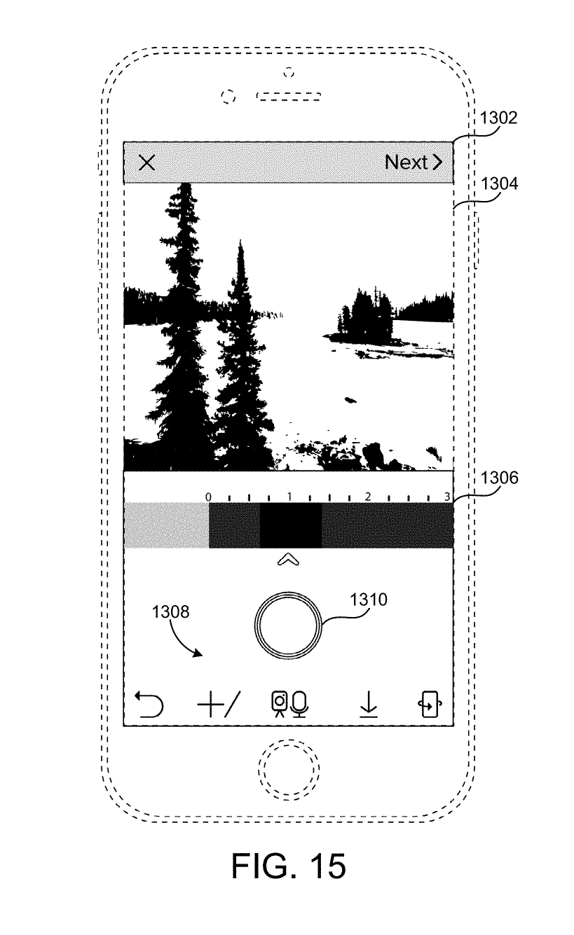

FIG. 13 is a screenshot diagram illustrating one embodiment of an original media recording screen 1302 on a GUI of a software application for video creation, editing, and sharing for social media. In an embodiment, the recording screen may include a camera preview screen 1304. The embodiment may also include a video recording timeline 1306 and one or more media capture and editing controls 1308 for selecting between recorded video or recorded sound, for switching from front to back video capture device, for navigation to the Jumpcut screen, for selection of video from the video library, and for navigation. The screen 1302 may include a media capture control 1310, such as a graphically displayed “Start” button. In the embodiment of FIG. 14, upon selecting the media capture control 1310, the control may change to display “HOLD” to continue to record the video content. In the embodiment of FIG. 15, the capture control button 1310 may not display text, but may be otherwise coded to show capture commands, such as a colored button, a shaped button, or the like.

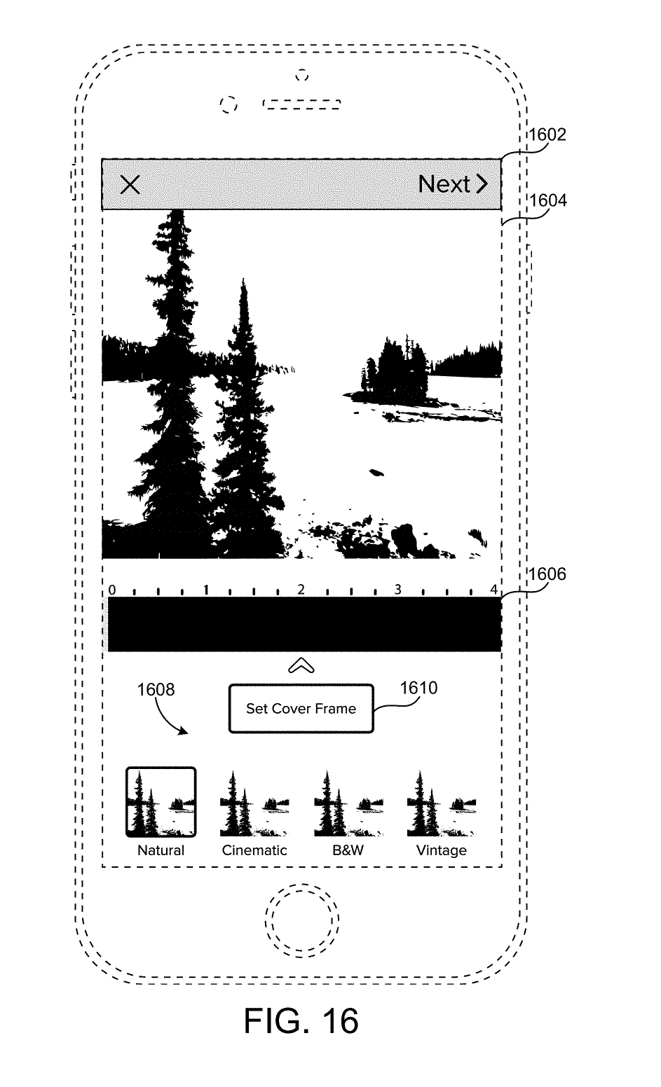

FIG. 16 is a screenshot diagram illustrating one embodiment of video filter selection screen 1602 on a GUI of a software application for video creation, editing, and sharing for social media. In an embodiment, the filter selection screen 1602 may include a filter preview screen 1604 for previewing the visual effects of a selected filter. The timeline 1606 may allow a user to select a portion of the media to which the filter is to be applied. The filter selection control 1608 may include a plurality of media filters that may be applied to the media. Media filters may include audio filters, video filters, and the like. The set frame control 1610 may be used to apply a selected filter to a selected portion of the media.

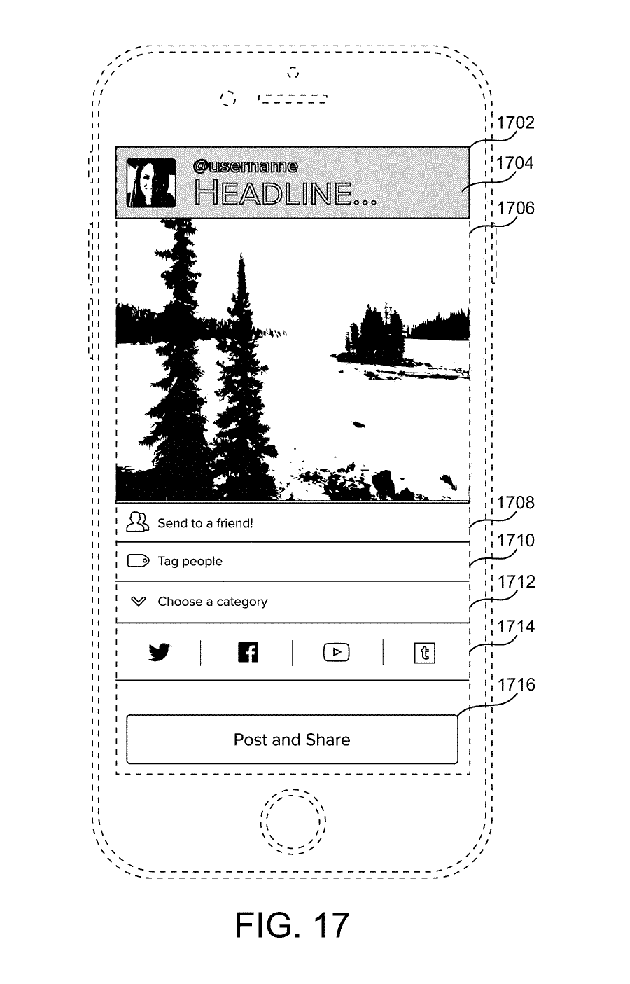

FIG. 17 is a screenshot diagram illustrating one embodiment of a media publication screen 1702 portion of a GUI for a software application for video creation, editing, and sharing for social media. In an embodiment, a user may apply a headline 1704 to a media publication, and see a preview in a preview panel 1706 of the media to be published. Additionally, the user may apply metadata to the media for publication, including options for sending the media directly to an associated account in field 1708, tag people, places or things featured in the media at field 1710, chose a category for categorization of the media in field 1712, and the like. Additionally, field 1714 may present a user with a plurality of affiliated or linked publication options through one or more accounts associated with the user on other social media outlets. Finally, the screen 1702 may include a post and/or share button 1716 for publishing the media and/or metadata.

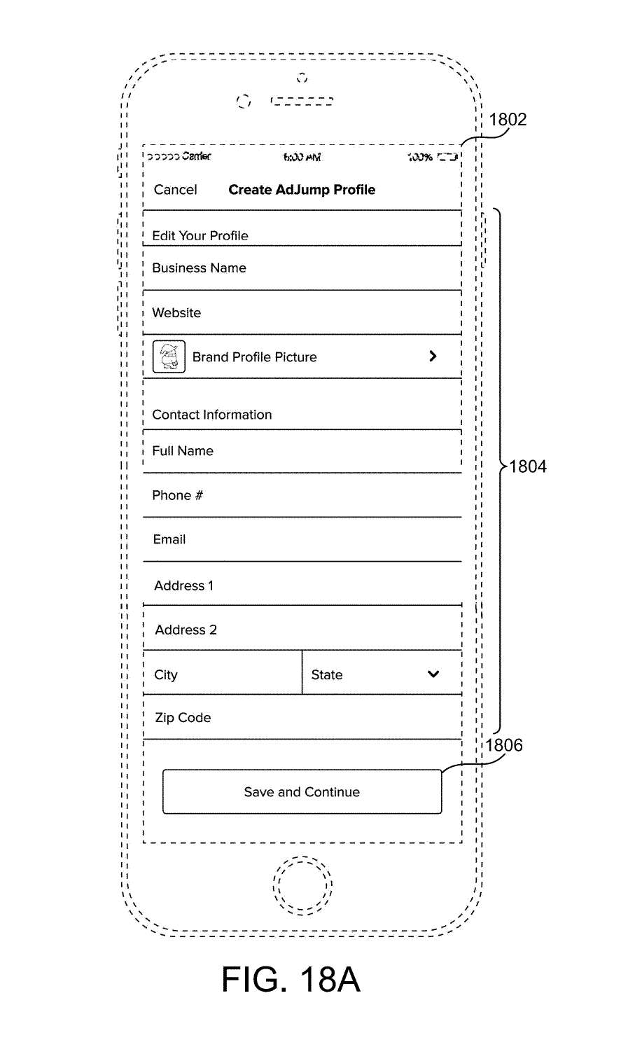

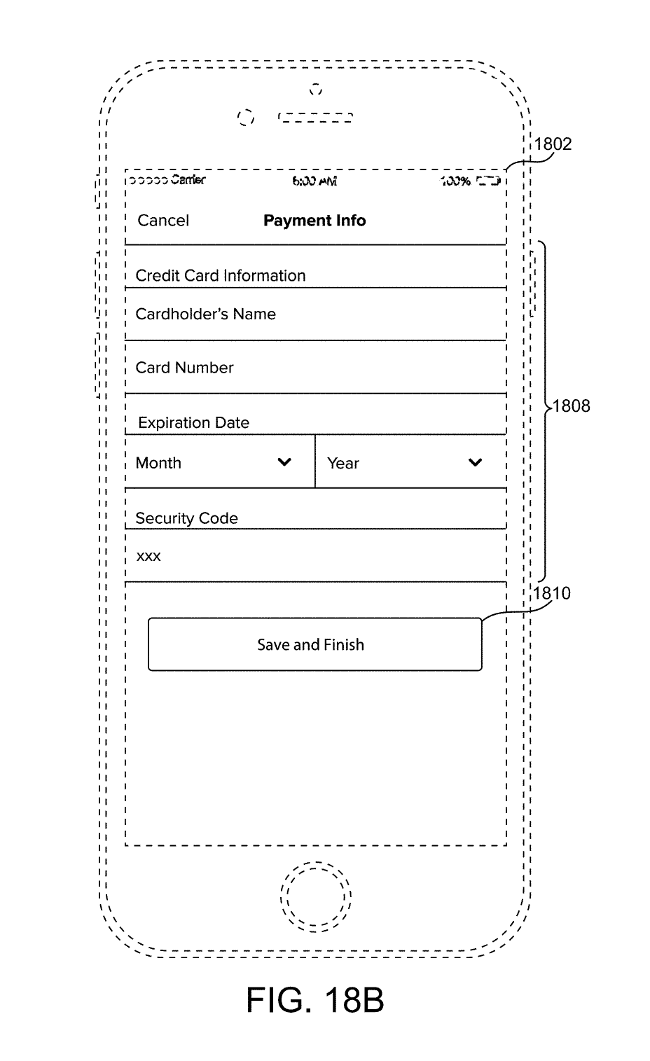

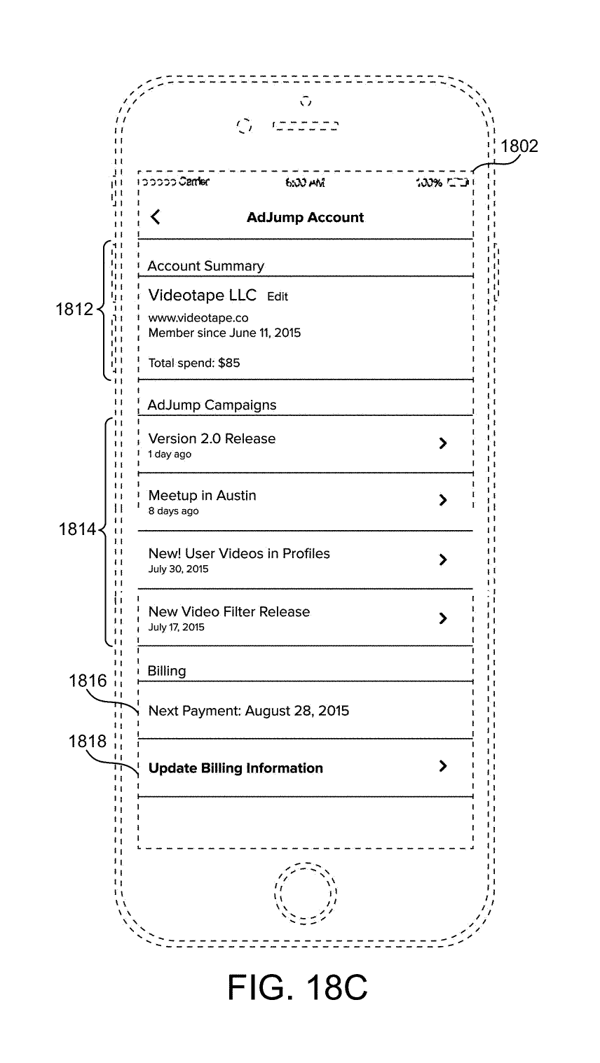

FIG. 18A illustrates a promoter screen 1802 for providing promoter contact information to register for a promoter account. Fields 1804 allow a user to establish a promoter account. The information may include business names, websites, logos, etc. Additionally, promoter contact information may be provided, including a contact's name, telephone number, email address, mailing address, etc. The submission button 1806 may be used to submit the personal information entered at fields 1804 and to navigate to other screens in the promoter portion of the application.

FIG. 18B is a further embodiment of the promoter screen 1802. In the depicted embodiment, one or more payment fields 1808 may be displayed for allowing a user to enter payment information. The payment information may be used to fund the promoter account. In an embodiment, the payment information may include credit card information. Additionally, the promoter screen 1802 may include a payment submission control 1810 for saving the payment information.

FIG. 18C is a further embodiment of the promoter screen 1802. The view described in FIG. 18C shows a summary of a promoter account. Fields 1812 displays the promoter account information. Fields 1814 display promotion campaign information. Field 1816 displays billing summary information. Control 1818 may provide the user with options for updating the promoter account information.

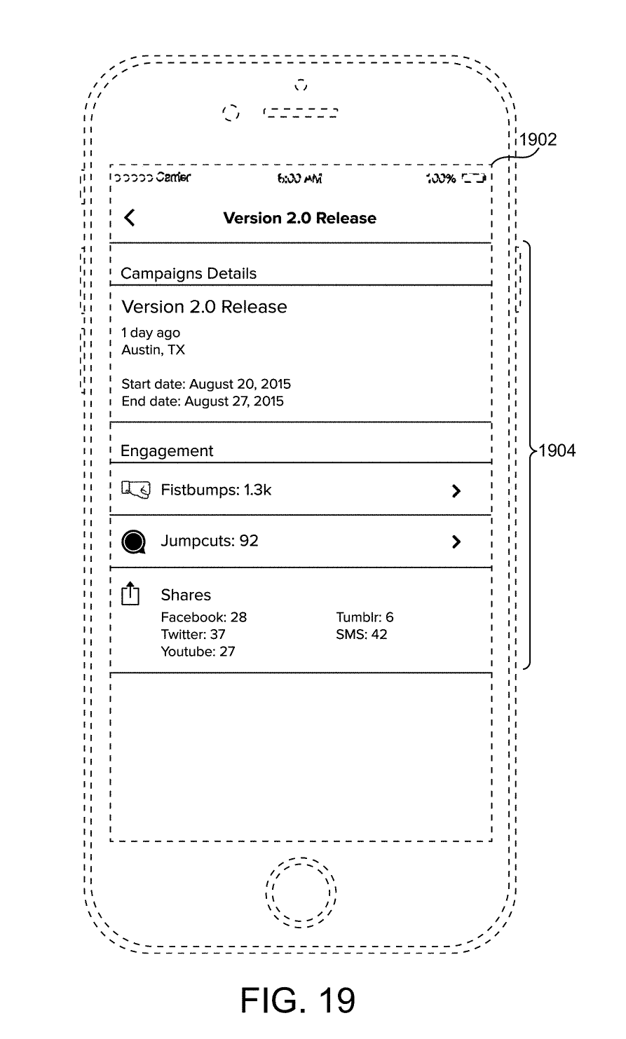

FIG. 19 illustrates an embodiment of a promoter campaign details summary screen 1902. In the depicted embodiment, fields 1904 provide a summary of information associated with the promoter campaign, including media versioning information, engagement data, etc.

As used herein, the process by which the user creates a promoter campaign and one or more associated advertising campaigns may be referred to as High Velocity Advertising™, and the process of creating or editing media content to generate a media advertisement may be referred to as an AdJump™. Beneficially, the advertising processes described herein provide a user with a fast, potentially relevant, and interactive solution to mobile advertising, as compared with traditional advertising methods. Audiences may record their own content directly into media advertisements, becoming part of the advertiser's narrative. Accordingly, advertising campaigns generated according to the present embodiments may generate a higher level of engagement with target audiences than seen in prior advertising methods because of the high levels of potential user interactivity.

In various embodiments, the system may present an advertising user with a variety of payment options, advertising promotion options, and advertising cost schemes. In certain embodiments, the advertising options may be related to a number of edits, referred to as Jumpcuts, made to the media associated with the advertising campaign. For example, the number of Jumpcuts may be indicative of a level of audience interaction associated with the advertising campaign, so the user may be required to pay a higher rate per user Jumpcut of the media. In another embodiment, the advertising platform may provide a portal for allowing an advertising to pay other platform users to perform Jumpcuts on their media, thus creating an impression of interest in the advertised product. In still further embodiments, a user may pay to have Jumpcuts of advertising media reposted or promoted in user media streams.

Additionally, the present embodiments provide advertisers with a cost effective and simple platform for generating media content for advertisements. In an embodiment, the advertisements may be length limited, making them highly consumable and less intrusive for users of the media sharing platform. Layer after layer of edits may be added to the advertisements by a variety of users, making the advertisement highly engaging and potentially self-propagating through client editing and republication.

Although the present embodiments are described specifically with reference to video media having a roughly square aspect ratio, one of ordinary skill will recognize that the present embodiments may be applied to any format of media including audio, still images, graphics, text, or video of various formats and aspect ratios.

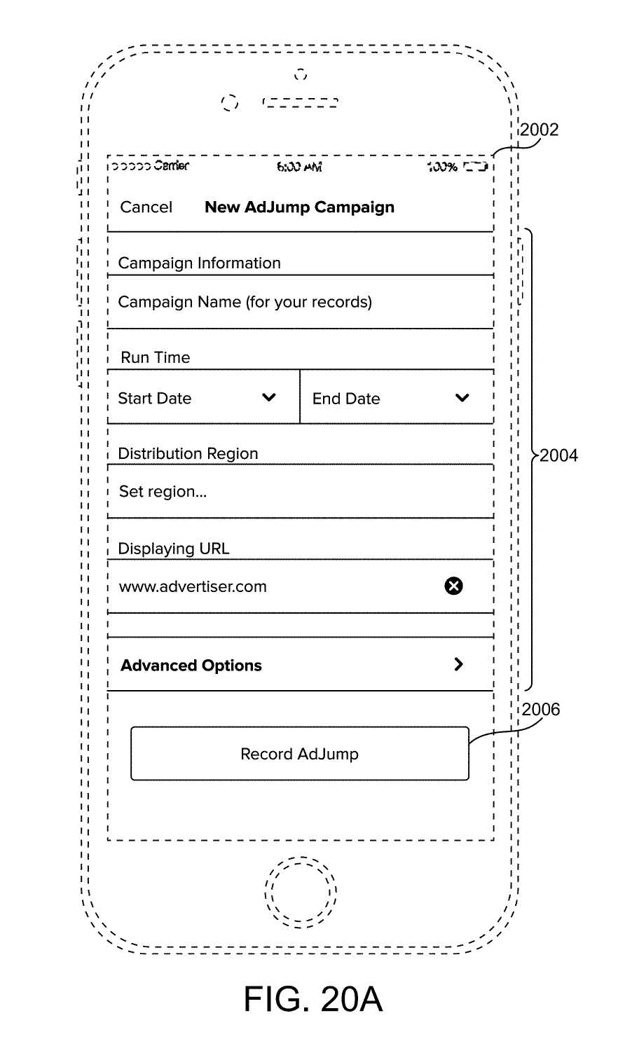

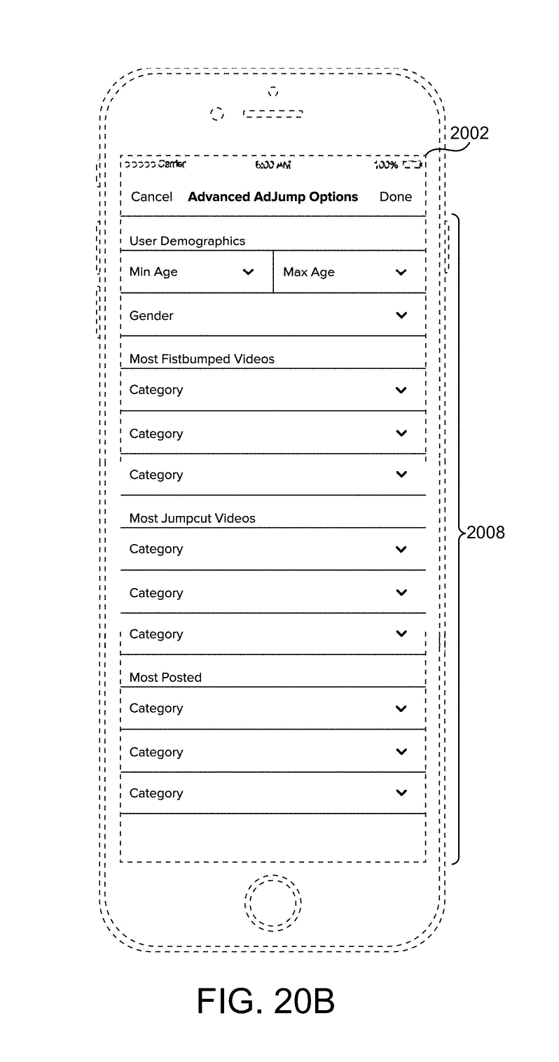

FIG. 20A illustrates an advertisement campaign screen 2002. The advertisement campaign may include a plurality of fields 2004 for creating an advertising campaign, such as a campaign title, a run time range, a distribution region, advertiser information, etc. Additionally, the screen 2002 may include a recording control 2006 for navigating the user to the recording and editing screens for creating the advertising media.

FIG. 20B illustrates a further embodiment of the advertisement campaign screen 2002 with fields 2008 for entering and displaying advanced option selections for the advertising campaign. The advanced options may include settings for target demographics, including age ranges, gender, categories, etc.

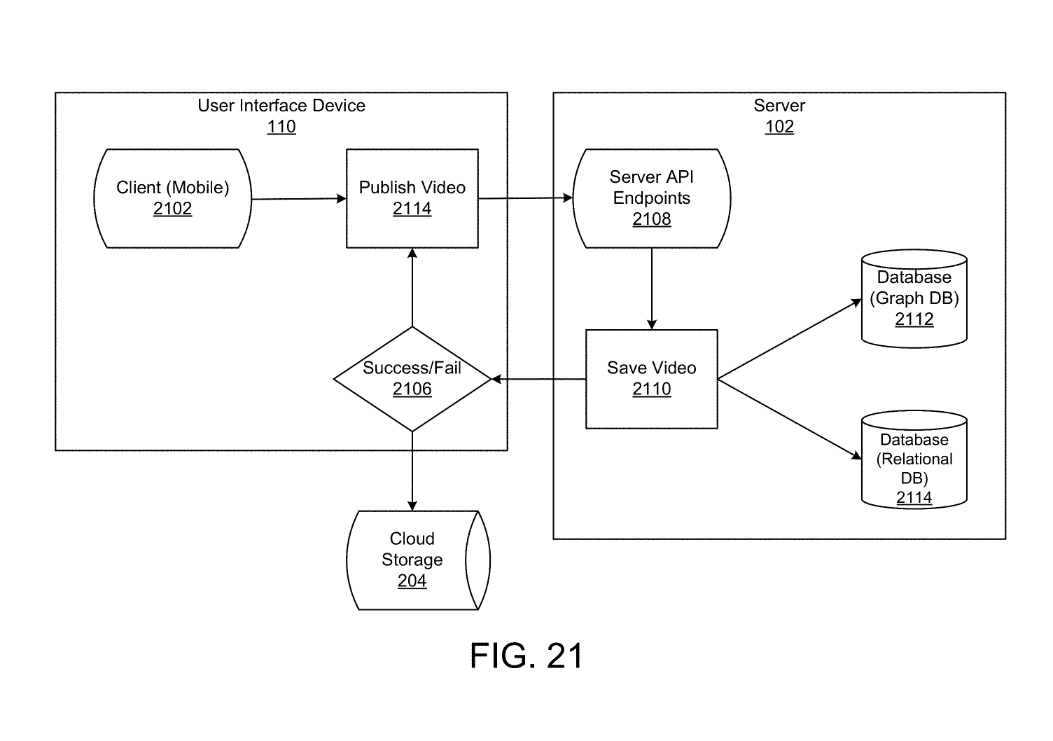

FIG. 21 is a schematic functional diagram illustrating an embodiment of operations for creating and publishing a video. In an embodiment, the user interface device 110 may be arranged as a client 2102 of the server 102. The client 2102 may include hardware and/or software modules configured to create and publish 2104 a video via an Application Program Interface (API) 2108 call to the server 102. The server 102 may then save 2110 the video node and/or save data or metadata associated with the video in a one or more databases 2112, 2114. In some embodiments, the databases 2112, 2114 may be stored on the data storage device 104. The server 102 may then provide a callback 2106 to the client 2102 indicating whether the save operation was successful or not. If the callback indicates success, then the client may transfer the media to be saved at the cloud storage 204.

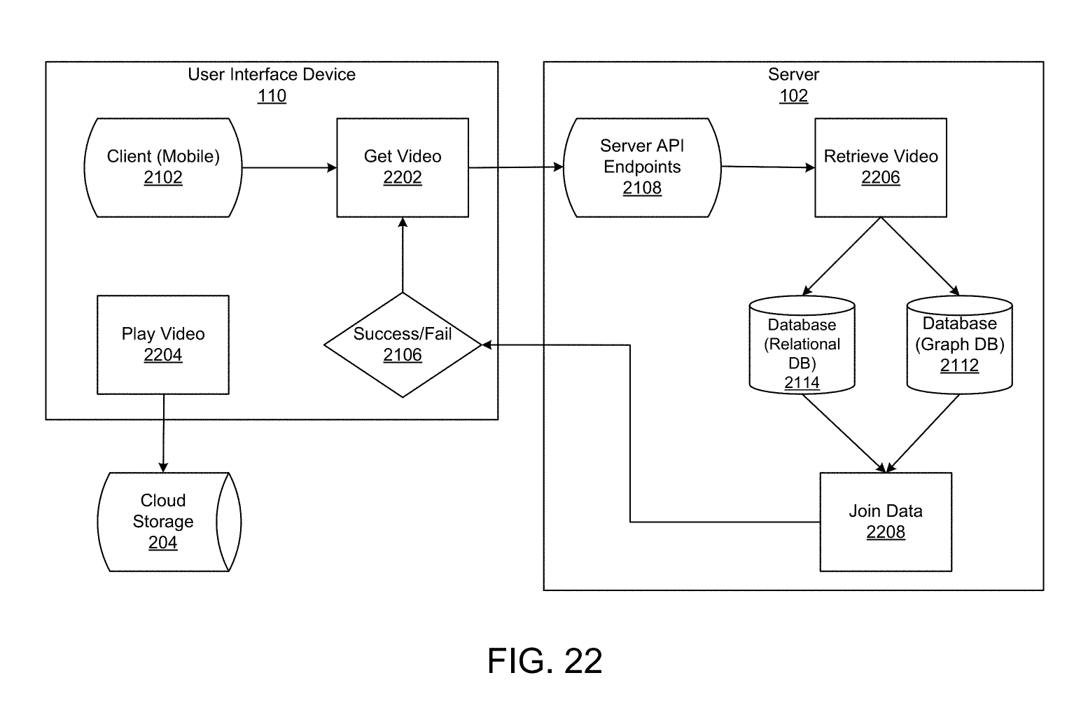

FIG. 22 is a schematic functional diagram illustrating an embodiment of hardware and/or software modules for reading a previously saved video. In an embodiment, the client 2102 sends an API call to get 2202 the video from the server 102. The server receives the command at an API endpoint 2108, and performs a retrieve video operation 2206. The server 102 may retrieve the video data, e.g., from a relational database 2114, and may also retrieve the video node and any parent videos from, e.g., a graph database 2112. The video data and the video node(s) may be joined 2208 and returned to the client. If the client is able to successfully download the video and data 2106, then the client may play the video 2204.

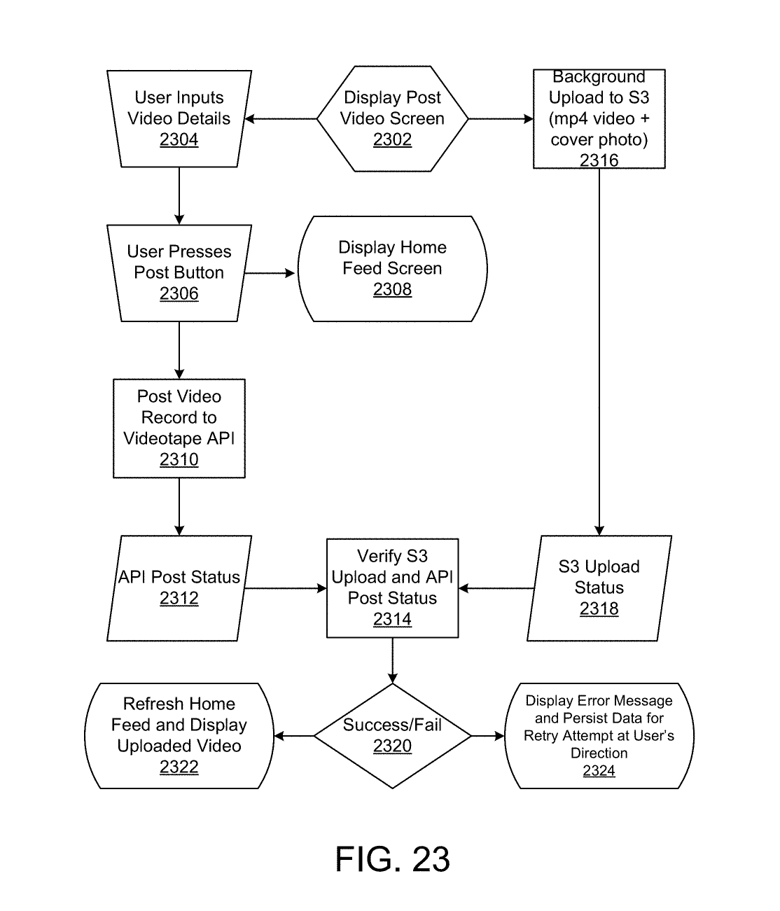

FIG. 23 is a flowchart diagram illustrating an embodiment of a method for video creation, editing, and sharing for social media. In an embodiment, the method describes a process for uploading a video from a client 110 to a server 102. The process may include creating a video and then displaying a post video screen to the user as shown at block 2302. The user may input video details at block 2304. In an embodiment, the client may simultaneously upload the video content to the server as shown at block 2316. The user may press a “post” button as shown at block 2306 and the user's display is returned to the home screen at block 2308. In the background, the client may post the video record to the server's API and communicate status updates with the server as shown at block 2312. The server may verify the upload at block 2314 and provide a status update at block 2318. If the upload is successful at block 2320, the home screen and feed may be refreshed to display the uploaded video at block 2322. If the upload fails, an error message may be displayed at block 2324.

Embodiments of apparatuses, systems and methods for video creation, editing, and sharing for social media are described. In particular, the present embodiments include components for copying and pasting snippets of media from a first media file to a second media file at a desired location within the second media file. In a further embodiment, media snippets may be copied, cut, or pasted within a single media file. For example, in an embodiment, a snippet of video may be copied from a first video file, and pasted at a selected position within a timeline of a second video file. The media files may be pasted over each other completely. In another embodiment, audio may be pasted over existing video. In another embodiment video may be pasted over existing audio. In various alternative embodiments, the media snippet may be otherwise merged with the second media file.

Such embodiments may include creation or designation of a virtual clipboard. The virtual clipboard may comprise a segment of memory designated by a video editing application for storage of media snippets copied or cut from the first media file. When the media snippet has been sent to the clipboard, an indicator may indicate to the user that the media snippet is available for pasting into a second media file. Controls within the application, and operated by the user, may determine how the media snippet is merged with the second media file.

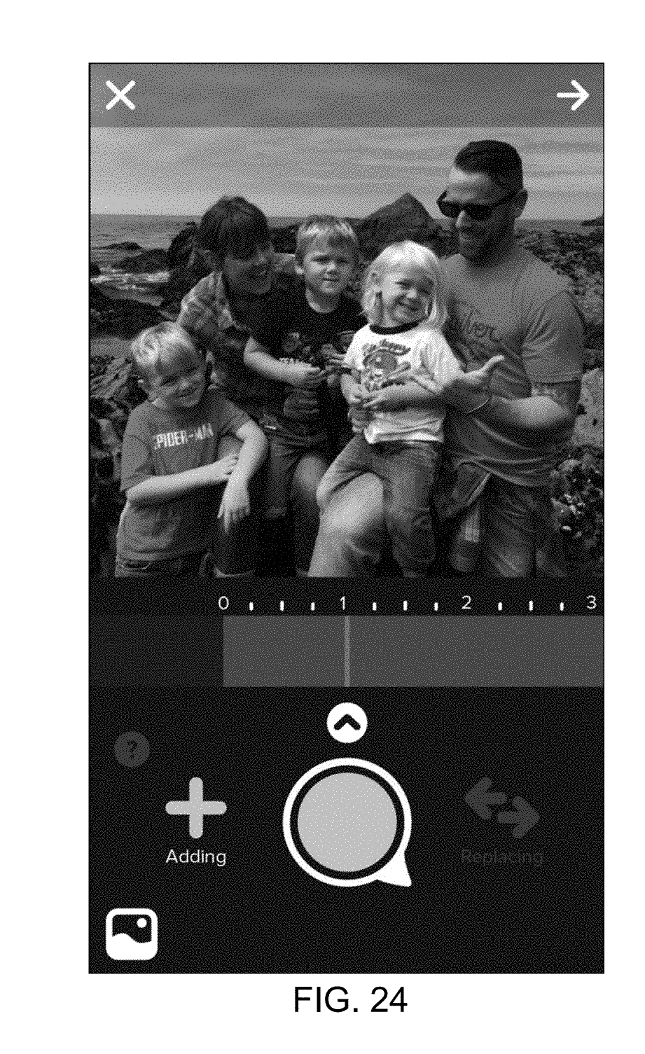

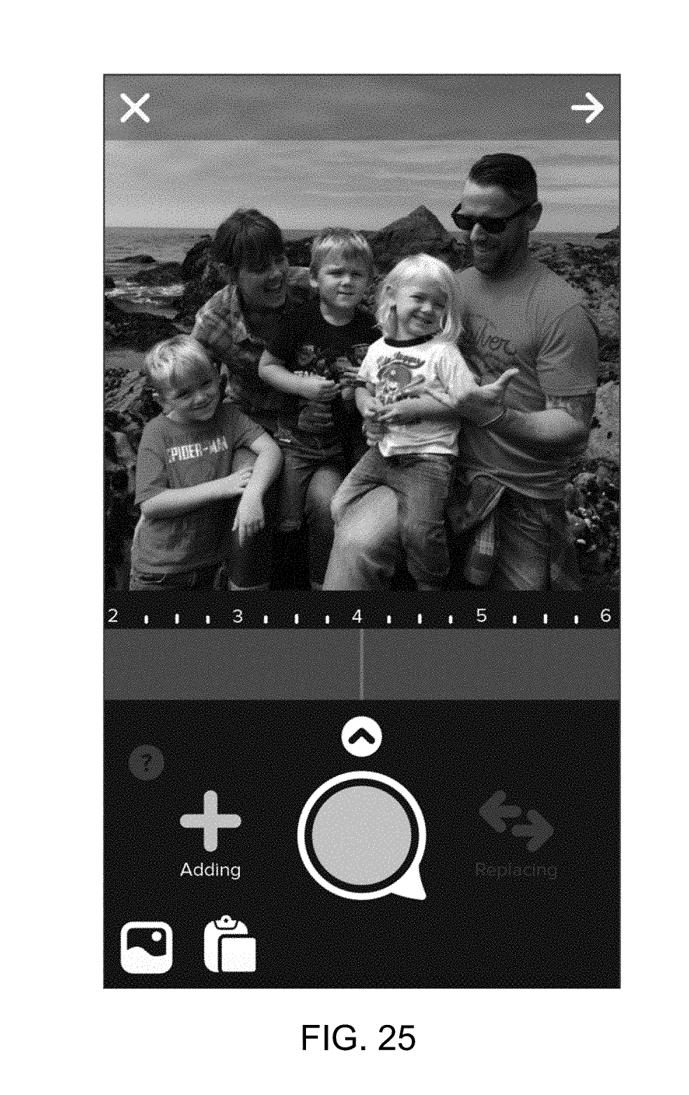

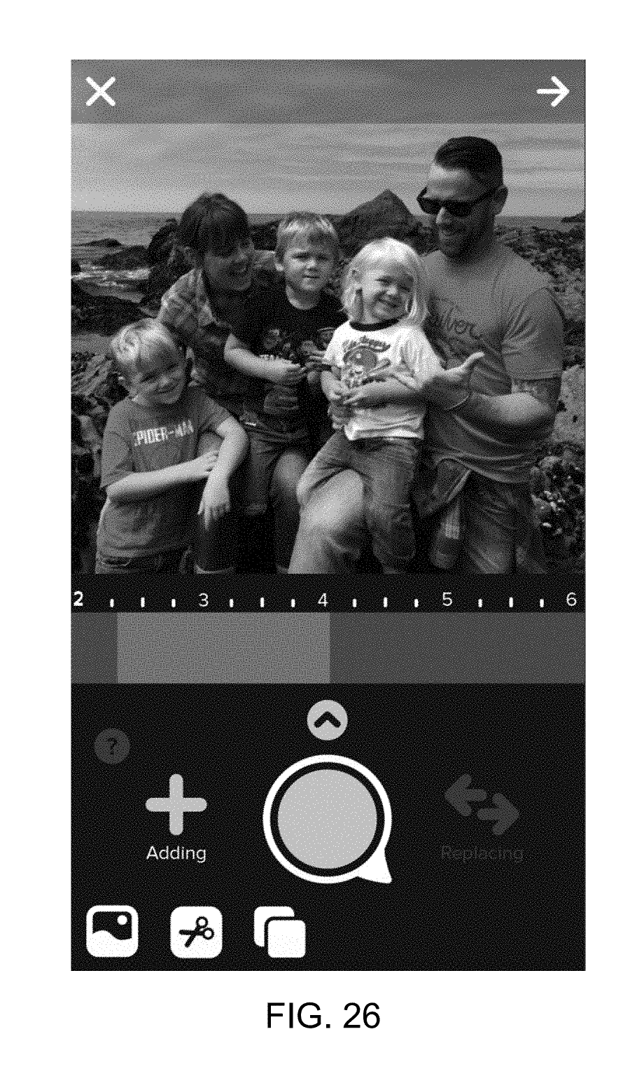

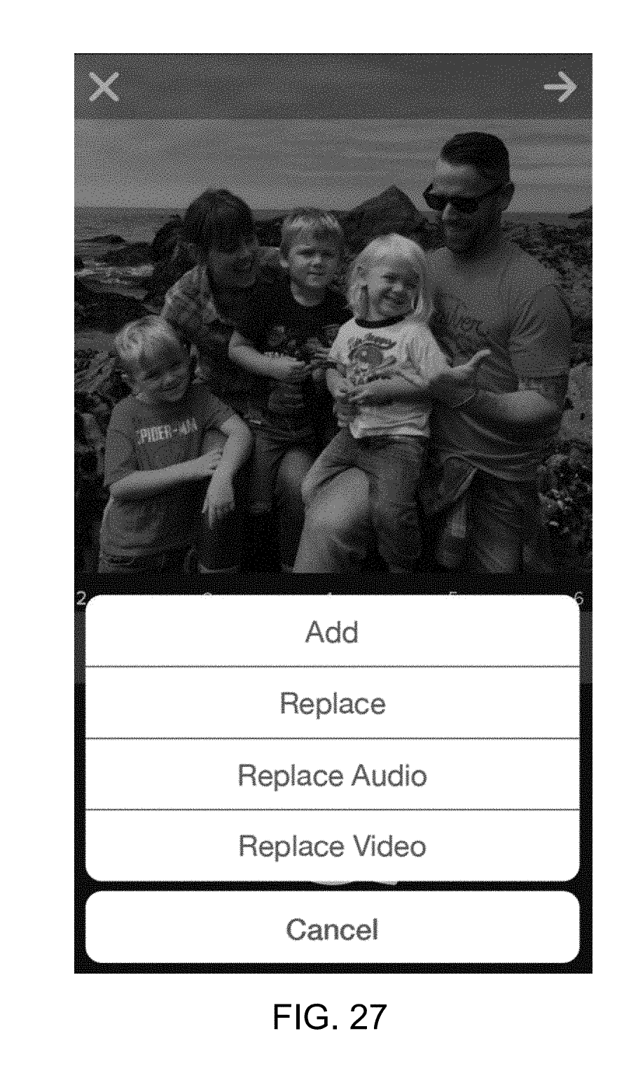

FIG. 24 shows the video experience (Jumpcut) UI if there is nothing on the clipboard. FIG. 25 shows the video experience UI if video had been copied or cut and is on the clipboard. The icon in the lower left, next to import, would paste that video segment into the above video. FIG. 26 shows the video experience UI if a portion of the video timeline is selected. Icons for Copy and Cut show to the right of the import button. This copies or cuts the selected video segment to the clipboard. FIG. 27 shows the video experience UI when Paste button is tapped. The action sheet gives options for introducing the video segment from the clipboard to the video in the player. You can add, replace, replace only audio, or replace only video when you paste.

In a further embodiment, a media snippet may be selected for display in a user feed of the social media platform. In such an embodiment, the media snippet may be referred to as a “cover burst.” The cover burst may include a segment of media, of a predetermined length, which is displayed and automatically played in a user feed. In a further embodiment, the media snippet may be down-sampled, compressed, or otherwise converted to a reduced data size, such that display of the cover burst in the user feed does not consume as much data bandwidth as would be the case with the original media snippet. In a further embodiment, cover burst may be looped, repeating either a predetermined number of times, or indefinitely until the user either scrolls past the displayed cover burst or selects the media file associated with the cover burst. In particular, the cover burst may be a three second snippet of video shown in a user feed in a preview loop. In a further embodiment, the cover burst may include a selectable area and an icon indicating that the cover burst is selectable for further playing of the associated media file. In such an embodiment, the icon may be a “play button,” such as a triangle shaped icon.

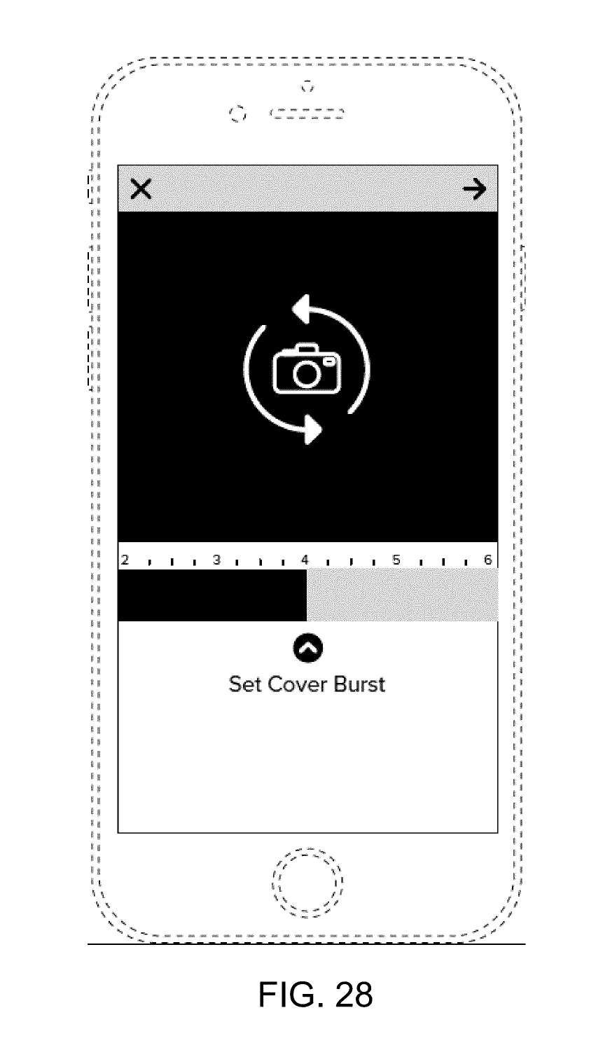

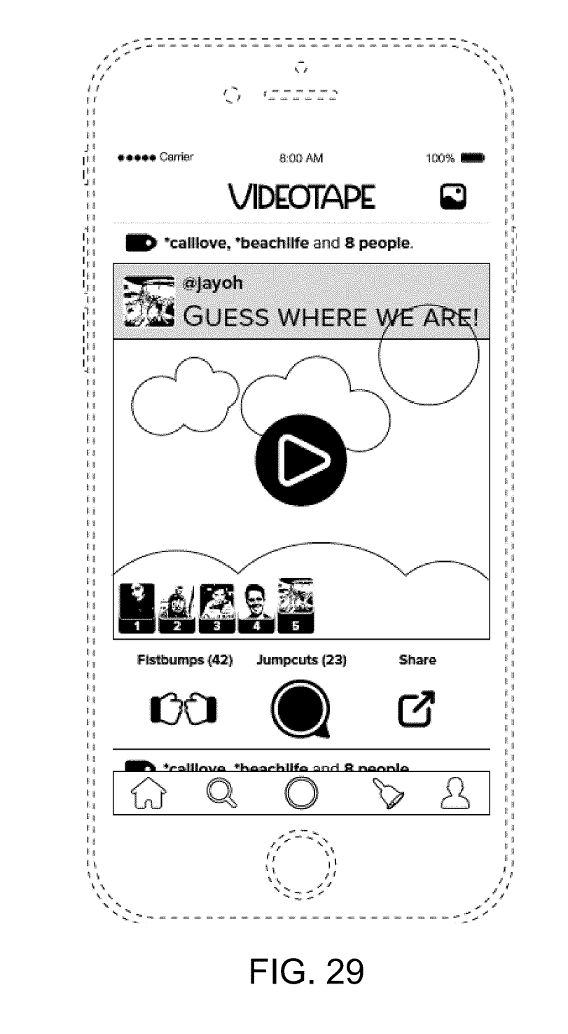

FIG. 28 shows how the user would see a video before interacting with it. A 3-second preview loop that we're calling Cover Burst would be looping in place of the video. FIG. 29 shows an embodiment of a user feed with a cover burst displayed thereon. In such an embodiment, there is a play button over the Cover Burst, and the video's details in the lower right corner show the duration of the full video. When the user taps the play button, the full video would load and play in the player.

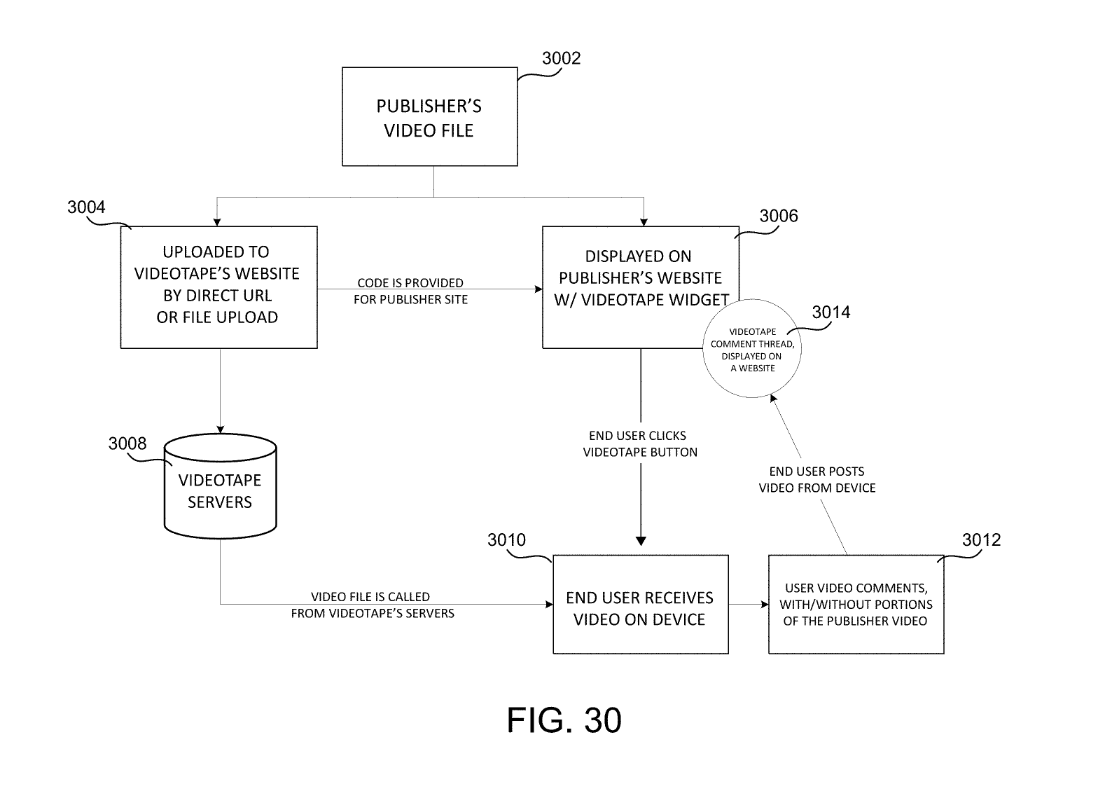

FIG. 30 is a schematic flowchart diagram illustrating one embodiment of a method for creating jumpcut media from a website source. At block 3002, a publisher's video file is obtained. At block 3004, the video file is uploaded to the video editing website by direct URL or file upload. At block 3008, the video file is uploaded to the servers 102. Alternatively, at block 3006, the video may file may be displayed on the publishers website via a video editing widget that has been preconfigured by the video publisher. At block 3010, the end user may receive the video on the user interface device 110. The user may create video comments, or edit the video using the jumcut/video editing features at block 3012. At block 3014, the user may post the edited media comment on a comment thread displayed on the publisher's website.

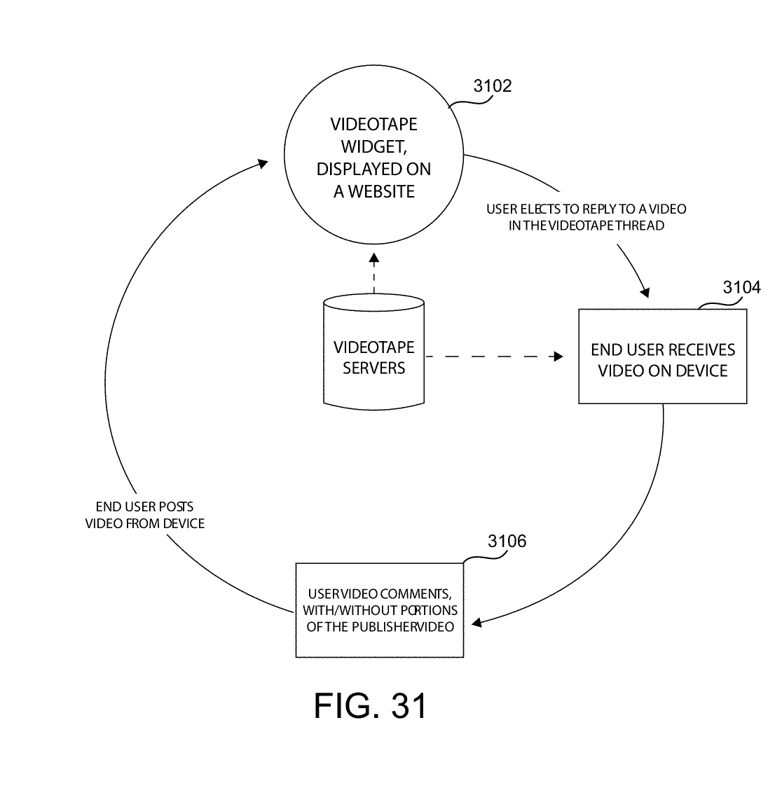

FIG. 31 is a schematic flowchart diagram illustrating one embodiment of a method for creating an independent jumpcut thread. In an embodiment, a widget is displayed on a website as shown at block 3102. The user may elect to reply to a video in a video discussion thread, by receiving the video on the user interface device 110 from the server 102 as shown at block 3104. The user may create a comment, with or without portions of the video file at block 3106. For example, the user may create a video snippet with added text, voiceover, music, or additional video using the jumpcut features described above. The user may then post the comment back to the media comment thread.

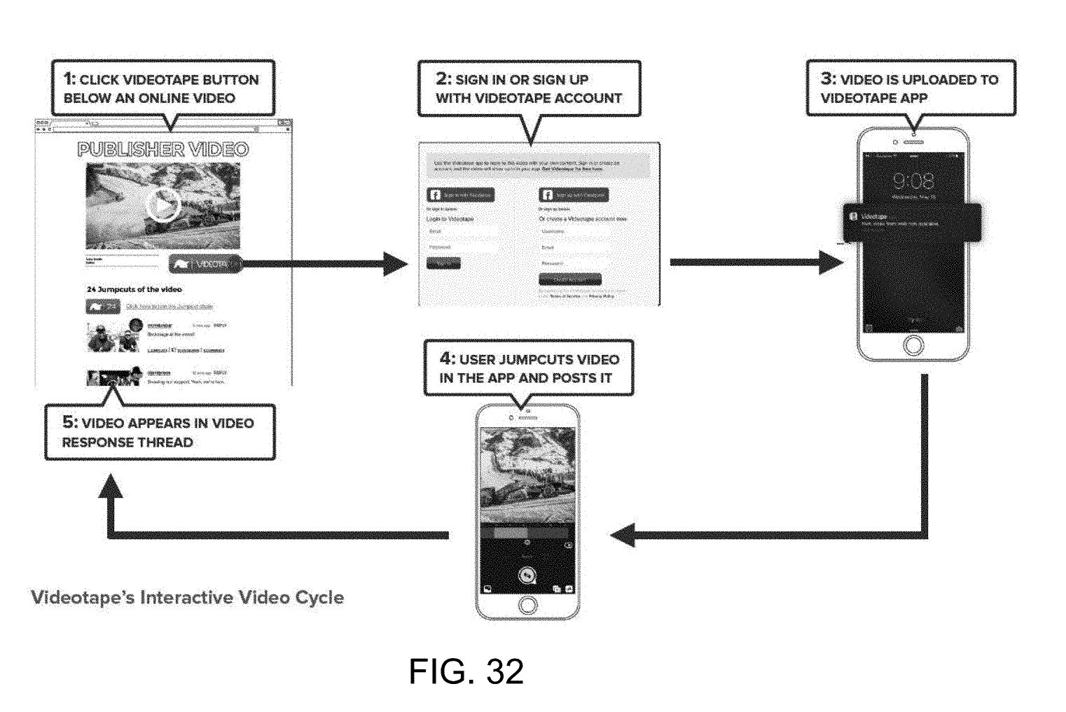

FIG. 32 illustrates an embodiment of an interactive video cycle. In step one, the user may visit a website featuring a publisher's video file. The user may click on a control button which causes a login prompt to be displayed at step 2. The login prompt may include fields for login or verification to the publisher's website, to the videotape servers, or both. The video file may be uploaded to the user interface device 110 at step 3. In an embodiment, the user may receive a notification when the video file has been completely uploaded. At step 4, the user may edit the video file using the jumpcut features described above to create a video comment file. At step 5, the user may upload the video comment file back to the publisher's website for display in the comments thread.

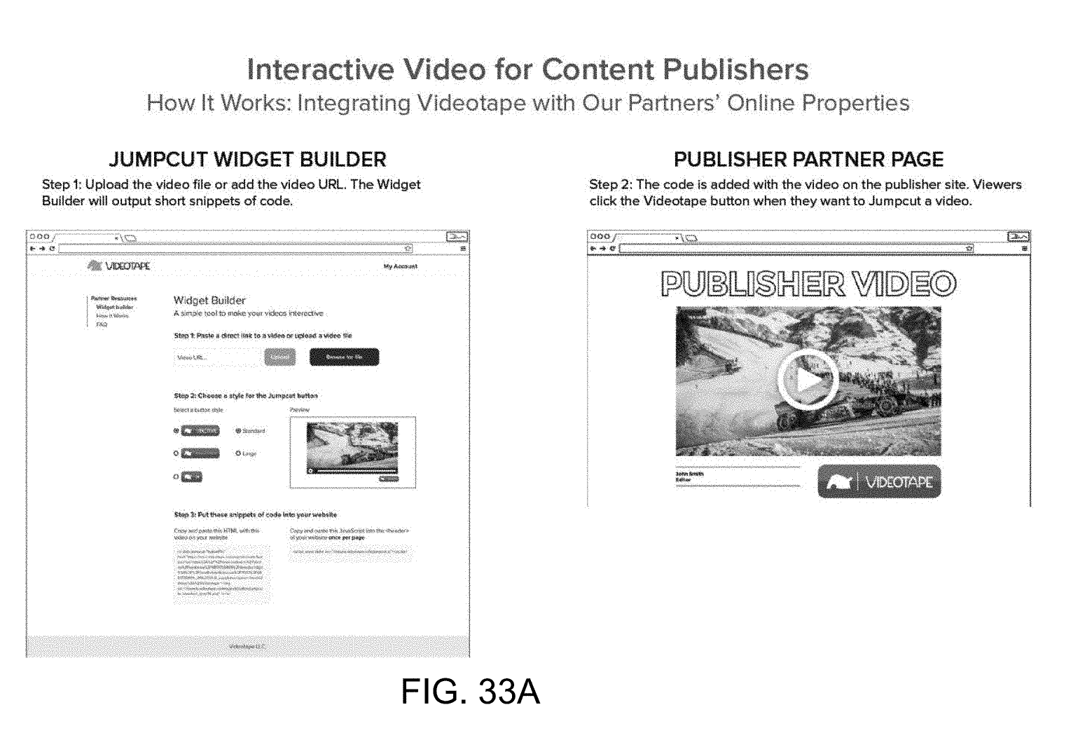

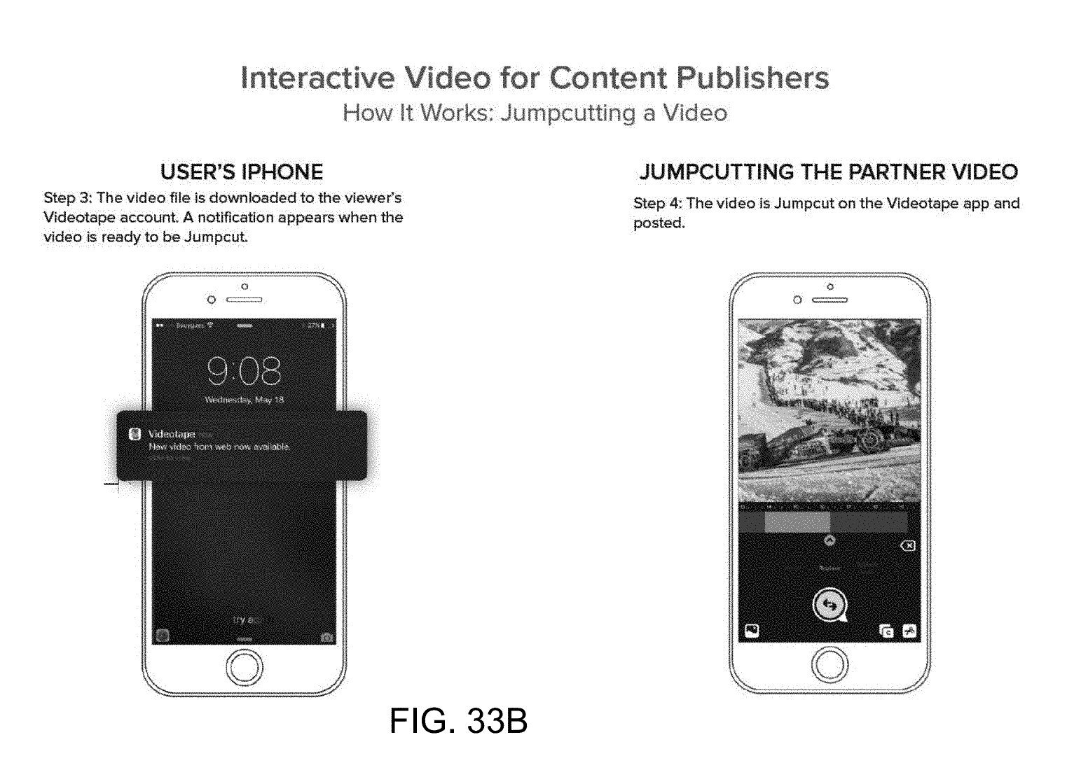

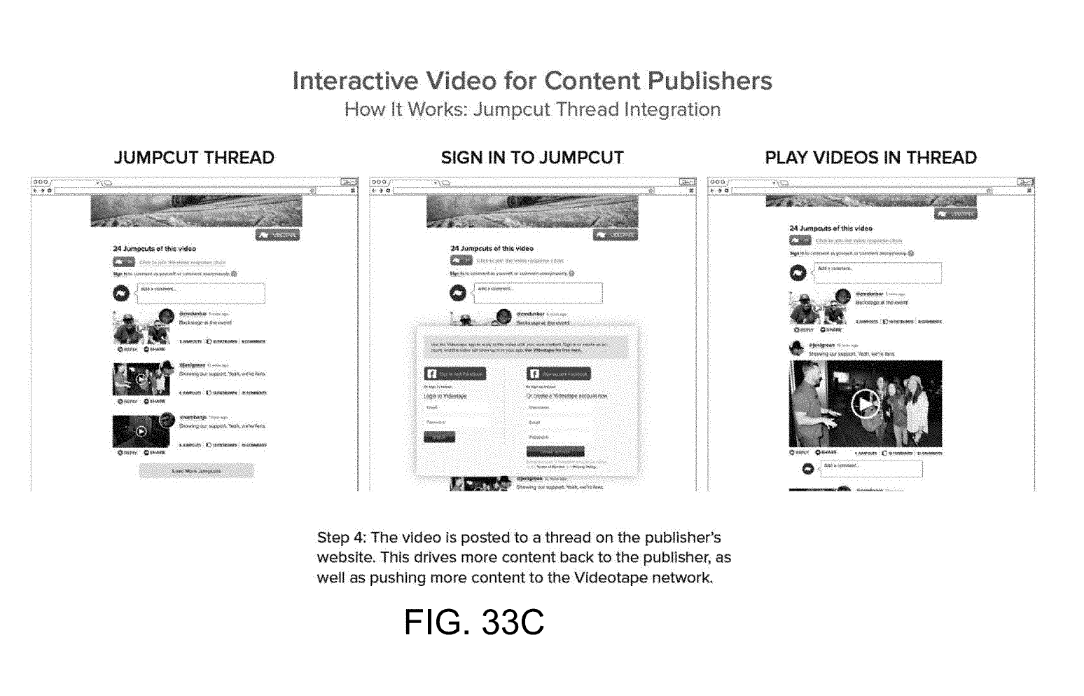

FIGS. 33A-C illustrate an embodiment of a process for generating jumpcut media commentary. This embodiment describes how a content publisher may integrate video commenting systems with their website. In the first step, the publisher may access a video editing widget builder for accessing a video editing web service. The publisher may identify a media file to be targeted, and provided with a list of controls for allowable edits. Alternatively, a publisher may not designate any specific video file, but rather designate a particular discussion thread as accessible for posting video comments.

At step 2, the code is tied to the video, discussion thread, or webpage. In an example, a control button may appear on the webpage indicating that video editing and video comment posting features are available. A user may click on the control button and media content may be transferred to the user interface device 110 as shown at step 3. The user may then create new content, or edit existing media content using the jumpcut or media editing features described above, as shown at step 4. In the steps illustrated in FIG. 33C, the user may post the media comment back to the publisher's website or discussion thread as a media comment. In further embodiments, a user may use a previous media comment as a basis for starting a new edited media comment. It will appreciated that these various embodiments are not necessarily tied to any specific video media file, but rather the user may create original content or bring in content from other sourced and post the media comments to the discussion thread.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
receiving a request for access to a media comment thread from a user interface device;
uploading a media file to the user interface device for editing;
receiving a media comment from the user interface device for including in the media comment thread.

2. The method of claim 1, further comprising editing the media file with an video editing utility on the user interface device.

3. The method of claim 2, wherein editing the media file further comprises a media cut operation.

4. The method of claim 3, wherein the media cut operation further comprises:
selecting a portion of the media file; and
removing the selected portion from the media file.

5. The method of claim 4, wherein the media cut operation further comprises placing the selected portion of the media file in a designated segment of memory.

6. The method of claim 2, wherein editing the media file further comprises a paste operation.

7. The method of claim 6, wherein the paste operation further comprises merging a selected media segment with the media file.

8. The method of claim 7, wherein merging further comprises receiving a designation of a position within the media file for merging the media segment.

9. The method of claim 1, further comprises displaying a looping rendering of a selected portion of the media file in the media content thread.

10. The method of claim 9, further comprising receiving a selection of the selected portion of the media file to display in the media content thread.

11. A system, comprising:
a processing device configured to process a request and determine whether to upload a media file to the user interface device for editing;
a communication interface coupled to the processing device and configured to:
receive the request for access to a media comment thread from a user interface device;
selectively upload a media file to the user interface device for editing in response to the determination from the processing device; and
receive a media comment from the user interface device for including in the media comment thread.

12. A system, comprising:
a processing device configured to execute an application for mobile video editing, the processing device configured to generate a request for access to a media comment thread and to edit a media file received in response to the request;
a communication interface coupled to the processing device and configured to:
send the request for access to a media comment thread to a remote server;
receive a media file for editing; and
send a media comment to the server for including in the edited media comment thread.

13. The system of claim 12, further comprising editing the media file with an video editing utility on the user interface device.

14. The system of claim 13, wherein editing the media file further comprises a media cut operation.

15. The system of claim 14, wherein the media cut operation further comprises:
selecting a portion of the media file; and
removing the selected portion from the media file.

16. The system of claim 15, wherein the media cut operation further comprises placing the selected portion of the media file in a designated segment of memory.

17. The system of claim 13, wherein editing the media file further comprises a paste operation.

18. The system of claim 17, wherein the paste operation further comprises merging a selected media segment with the media file.

19. The system of claim 18, wherein merging further comprises receiving a designation of a position within the media file for merging the media segment.

20. The system of claim 12, further comprises displaying a looping rendering of a selected portion of the media file in the media content thread.
The system of claim 20, further comprising receiving a selection of the selected portion of the media file to display in the media content thread.
